(19) United States
(12) Patent Application Publication
(10) Pub. No.: US 2026/0184308 A1
(43) Pub. Date: Jul. 2, 2026

(54) METHODS OF QUALITATIVE AND QUANTITATIVE VERIFICATION OF COMPLEX LEARNING-ENABLED SYSTEMS AND TEMPORAL LOGIC VERIFICATION

(71) Applicants: Toyota Motor Engineering & Manufacturing North America, Inc., Plano, TX (US); Board of Regents of the University of Nebraska, Lincoln, NE (US)

(72) Inventors: Bardh Hoxha, Canton, MI (US); Georgios Fainekos, Novi, MI (US); Hideki Okamoto, Ann Arbor, MI (US); Danil Prokhorov, Canton, MI (US); Hoang-Dung Tran, Lincoln, NE (US)

(73) Assignees: Toyota Motor Engineering & Manufacturing North America, Inc., Plano, TX (US); Toyota Jidosha Kabushiki Kaisha, Toyota-shi Aichi-ken (JP); Board of Regents of the University of Nebraska, Lincoln, NE (US)

(21) Appl. No.: 19/003,350

(22) Filed: Dec. 27, 2024

(51) Int. Cl. G06F 21/64

(52) U.S. Cl. CPC B60W 30/16

(57) ABSTRACT

A qualitative and quantitative (Q²) method for verifying safety of movement of complex learning-enabled cyber-physical systems (Le-CPS) using a computer is provided. The method includes determining an initial set of states of the Le-CPS. The computer is used for determining a reachable set of the Le-CPS using a probstar reachability algorithm saved in memory of the computer. The computer includes a Q² algorithm saved in the memory that is configured is used to simultaneously check (i) if the reachable set satisfies a predetermined safety constraint (qualitative verification) and (ii) determine a probability of satisfaction that the reachable set will satisfy the predetermined safety constraint (quantitative verification). Movement of the Le-CPS is planned based on the step of using the computer including the Q² algorithm.

### TECHNICAL FIELD

The present specification generally relates to qualitative and quantitative verification of complex learning-enabled systems and temporal logic verification.

### BACKGROUND

Deep neural networks (DNNs) have become a favorable choice for addressing multiple challenges in multiple domains, ranging from healthcare, natural language processing, and market prediction to autonomous driving. In safety-critical domains like autonomous driving, the failures of DNNs interacting with the physical world under unknown uncertainties can lead to unintended consequences. Therefore, achieving the correctness of learning-enabled autonomous systems can be important to enhancing the applicability of DNNs in safe-achieving domains. The correctness of a learning-enabled system can be verified at the component level or the system level. The component level verification focuses on the safety and robustness of deep neural networks under bounded input uncertainties or attacks. Meanwhile, verification at the system level focuses on the safety of a closed-loop neural network control system under bounded input conditions, involving the complex interaction between the neural network controllers and the physical plan model.

### SUMMARY

In one embodiment, a qualitative and quantitative (Q²) method for verifying safety of movement of complex learning-enabled cyber-physical systems (Le-CPS) using a computer is provided. The method includes determining an initial set of states of the Le-CPS. The computer is used for determining a reachable set of the Le-CPS using a probstar reachability algorithm saved in memory of the computer. The computer includes a Q² algorithm saved in the memory that is configured is used to simultaneously check (i) if the reachable set satisfies a predetermined safety constraint (qualitative verification) and (ii) determine a probability of satisfaction that the reachable set will satisfy the predetermined safety constraint (quantitative verification). Movement of the Le-CPS is planned based on the step of using the computer including the Q² algorithm.

In another embodiment, a system configured to verify safety of movement of a complex learning-enabled cyber-physical system (Le-CPS) using a computer includes a computer comprising a memory comprising a probstar reachability algorithm and a Q² algorithm. The memory has instructions, which when executed by a processor, causes the computer to determine an initial set of states of the Le-CPS and determine a reachable set of the Le-CPS using the probstar reachability algorithm. The computer uses the Q² algorithm to (i) simultaneously check if the reachable set satisfies a predetermined safety constraint (qualitative verification) and (ii) determine a probability of satisfaction that the reachable set will satisfy the predetermined safety constraint (quantitative verification). Movement of the Le-CPS is planned based on use of the Q² algorithm by the computer.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example of a complex Le-CPS with multiple network components, according to one or more embodiments shown and described herein;

FIG. 2 depicts a reachability graph of the complex Le-CPS of FIG. 1 for n=2, according to one or more embodiments shown and described herein;

FIG. 3 depicts an algorithm for computation of a probstar's probability, according to one or more embodiments shown and described herein;

FIG. 4A depicts part of an algorithm for reachability analysis of Le-CPS using Probstar Algebra, according to one or more embodiments shown and described herein;

FIG. 4B depicts part of the algorithm of FIG. 4A, according to one or more embodiments shown and described herein;

FIG. 5A depicts part of an algorithm for Q² verification of Le-CPS, according to one or more embodiments shown and described herein;

FIG. 5B depicts part of the algorithm of FIG. 5A, according to one or more embodiments shown and described herein;

FIG. 6A depicts the probstar reachable sets for 10 time steps of Dᵣ−D_{safe} vs. ν_{ego}, according to one or more embodiments shown and described herein;

FIG. 6B depicts the counter state (output) sets Cₛ, according to one or more embodiments shown and described herein;

FIG. 6C depicts the counter initial sets Cᵢ of the ACC system controlled by the 5×20-network, according to one or more embodiments shown and described herein;

FIG. 7A depicts exact qualitative results using the exact reachability scheme, i.e., p_{ƒ}=0, for verification, according to one or more embodiments shown and described herein;

FIG. 7B depicts exact quantitative verification results using the reachability scheme, according to one or more embodiments shown and described herein;

FIG. 7C depicts the estimated violation probability Qt and its lower and upper bounds Qtₜₕ and Qtᵤₕ when using the appropriate reachability for verification with filtering probability, according to one or more embodiments shown and described herein;

FIG. 8 depicts how p_{ƒ} affects the number of reachable sets (Nᵣₛ), according to one or more embodiments shown and described herein;

FIG. 9 schematically depicts an emergency braking system architecture and its Simulink model, according to one or more embodiments shown and described herein;

FIG. 10 schematically depicts a closed loop Learning Enabled System (LES), according to one or more embodiments shown and described herein;

FIG. 11 depicts equivalences defining the DT-STL semantics, according to one or more embodiments shown and described herein;

FIG. 12 depicts scopes of a specification and its ADNF derivation, according to one or more embodiments shown and described herein;

FIG. 13 depicts an algorithm for derivation of verifiable disjunctive normal form, according to one or more embodiments shown and described herein;

FIG. 14 depicts k-step Reachability of LES, according to one or more embodiments shown and described herein;

FIG. 15A depicts part of an algorithm for depth-firs search reachability for LEX-(REVIEW), according to one or more embodiments shown and described herein;

FIG. 15B depicts part of the algorithm of FIG. 15A, according to one or more embodiments shown and described herein;

FIG. 16 depicts a verification algorithm for LES, according to one or more embodiments shown and described herein;

FIG. 17 is a table for properties of interest of the learning-enabled ACC system, according to one or more embodiments shown and described herein;

FIG. 18 is a table of verification results for LE-ACC with network controller N_{5×20}, according to one or more embodiments shown and described herein;

FIG. 19A depicts a plot of conservativeness vs. number of steps, according to one or more embodiments shown and described herein;

FIG. 19B depicts a plot of constitution vs. number of steps, according to one or more embodiments shown and described herein;

FIG. 20A depicts a plot of analysis times vs. number of steps (T), according to one or more embodiments shown and described herein;

FIG. 20B depicts a plot of analysis times vs. p_{ƒ} (T=30), according to one or more embodiments shown and described herein;

FIG. 21A depicts a plot of number of traces vs. number of steps, according to one or more embodiments shown and described herein;

FIG. 21B depicts a graph of number of CDNF vs. number of steps, according to one or more embodiments shown and described herein;

FIG. 22A depicts a graph of length of CDNF for φ′₄ verification, according to one or more embodiments shown and described herein; and

FIG. 22B depicts a plot of a satisfaction trace, according to one or more embodiments shown and described herein.

### DETAILED DESCRIPTION

The present disclosure is directed to system-level verification, where current system-level verification approaches for learning-enabled cyber physical system (Le-CPS) provide qualitative results, i.e., answering Safe, Unsafe, or Unknown. In practice, quantitative verification results, e.g., probability of collision of a system controlled vehicle, give more information about the system safety (i.e., how severe it is), which is useful for decision-making or planning processes. Moreover, environmental uncertainties (in sensing, perception, and actuating) are more naturally modeled in a probabilistic manner. It is believed that no current approach can provide quantitative verification results at a system level. To address this, a Q² verification approach for Le-CPS at the system level that can provide simultaneously qualitative and quantitative results based on probstar reachability, a recent approach for neural network verification. Probstar is a set representation extended from the star set. Mathematically, it is an affine mapping of a constrained (truncated) Gaussian distribution, i.e., random variables reside in an H-polyhedron. Therefore, when using probstar to represent the reachable set of a Le-CPS, the reachable set can be simultaneously checked if the reachable set satisfies safety constraints (qualitative verification) and compute the probability of this satisfaction (quantitative verification).

System-level verification can be challenging for most state-of-the-art techniques when the system model is too complex. For example, the system may comprise multiple neural network components that interact with each other and the physical plant. Abstraction-based verification techniques that do not preserve the relationship between inputs and outputs of all system components may quickly result in a very conservative abstraction that is useless for verification. Due to complexity, the state-of-the-art mainly focuses on qualitatively verifying a simple system model in which a neural network controller controls a physical plant. Probstar set representation can be used, probstar reachability is a promising approach to qualitatively and quantitatively verify complex system models with multiple learning-enabled components, since it preserves the inputs and outputs relationship of system components in the analysis. Developing the probstar reachability of a complex Le-CPS is substantially challenging in which there is a need to efficiently track the dependency between many probstars in all components to construct precise reachable sets of the system in multiple time steps.

To address the substantial challenge in verification of complex Le-CPS, probstar algebra is introduced, built on the concept of probstars dependency, which provides a set of efficient set computation and construction operators such as composition ∘, decomposition, parallel composition, and Minkowski sum ⊕. Probstar algebra can also provide a way to determine dependency between the reachable sets of multiple components based on their interaction. Using probstar algebra, the exact and approximate probstar reachability algorithms to construct the probabilistic reachable sets for a complex Le-CPS with multiple neural network components interacting with each other and a linear physical plant. Q² verification is performed for complex Le-CPS by constructing the intersection between the constructed reachable sets and the unsafe constraints. At a specific step, if the intersection is an empty probstar, then the system is safe with a probability of collision of 0. Otherwise, the system is unsafe, with probability being the probability of the intersected probstar being satisfied. It noted that the Q² verification can be exact (sound and complete) or approximate (sound but incomplete). The exact verification scheme provides the exact probability of a safety probability being satisfied, while the approximate scheme obtains the estimated lower and upper bounds of this satisfaction probability. Probstar algebra can also construct and visualize the complete counterexamples by exploiting the dependency between the input set and the violated output reachable sets via constraints on random predicate variables. The proposed Q² verification approach may be implemented using StarV, a tool for verifying DNNs and complex Le-CPS. Its efficiency, timing performance, and scalability are evaluated using the emergency braking and adaptive cruise control benchmarks. In summary, contributions of the present disclosure are:
(i) The development of probstar algebra to allow efficient (fast and precise) set operations based on reachable set dependency.
(ii) The development of a Q2 verification approach for complex Le-CPS with multiple learning-enabled components using probstar algebra and reachability.
(iii) Rigorous evaluation regarding efficiency, timing performance, and scalability.

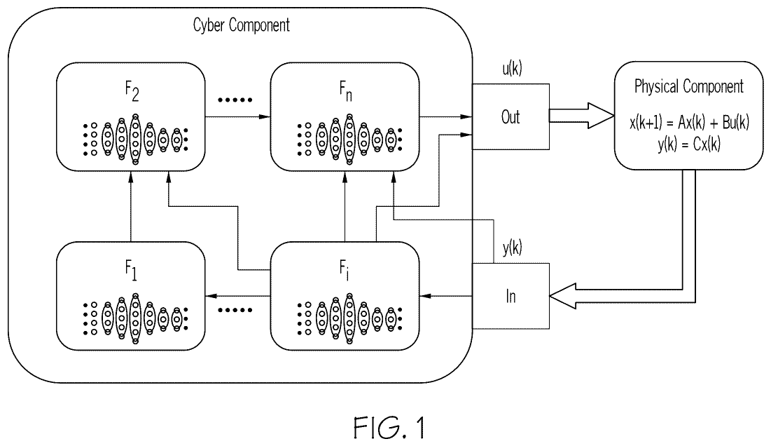

Referring to FIG. 1, an example of a complex Le-CPS model with multiple neural network components interacting with a discrete linear physical component with the following dynamics:

$$x ( k + 1 ) = Ax ( k ) + Bu ( k ) ,$$

$$y ( k ) = Cx ( k ) ,$$

where x(k) and y(k) are the plant's state and output at the time step k; A and B are the system and control matrices, respectively; and C is the output matrix. The neural networks Fi, 1≤i≤n are feedforward neural networks (FNN) with piecewise activation functions. Each network consists of an input, output, and multiple hidden layers. Given an input vector x, the output of a network is determined by 1) the weight matrices W_{l,l-1}, representing the weighted connection between neurons of two consecutive layers l−1 and 1, 2) the bias vectors bₗ of each layer, and 3) the piecewise activation function ƒ(·) applied at each layer. Mathematically, the output of a neuron i is given as follows:

$${y}_{i} = f ( {\sum }_{j = 1}^{n} {ω}_{ij} {x}_{j} + {b}_{i} ) ,$$

where xⱼ is the j^{th} input of the i^{th} neuron, ωᵢⱼ is the weight from the j^{th} input to the i^{th} neuron, and bᵢ is the bias of the i^{th} neuron.

The complex Le-CPS is modeled as a graph G= [symbol] V, E [symbol] , where the vertices V represents a list of components V=[P, F₁, . . . , Fₙ], (including physical plant P and neural network components Fᵢ, 1≤i≤n) and E is the edge of the graph representing the information flow between components. The edge is a list of maps containing mapping matrices that determine which component's outputs will be the inputs to other components. The mapping matrices can also be used to normalize/scale the values of the mapping outputs. In the example of FIG. 1, it is assumed that there are only two neural network components in the system, i.e., n=2, there is V=[P, F₁, F₂] and the edge of the system graph is E=[M_{P}, M_{F}, M_{F}], where M_{P}=[[ ], M^{F1}, M^{F2}] indicating that the outputs of the plant will be the inputs to the networks F₁ and F₂, M_{F1}=[[ ], [ ],

$$[ {M}_{F 1}^{F 2} ]$$

stating that the outputs of F₁ will be the inputs of F₂,

$${M}_{F 2} = [ {M}_{F 2}^{P} ,$$

[ ], [ ]] illustrating that the output of F₂ will be the input of plant P.

### Problem Formulation

Definition 1 (Reachability Graph). Given a complex Le-CPS system G= [symbol] V, E [symbol] , the T-step reachability graph represents the order of the reachable set computation through a system's components for T time steps. It is the sequential composition of T step-reachability graphs.

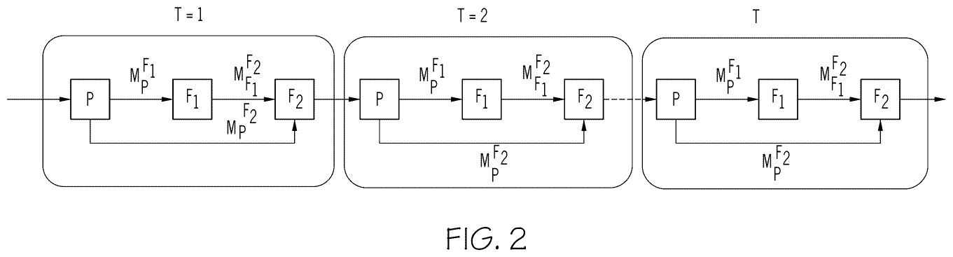

The reachability graph of the example with n=2 (FIG. 1) is depicted in FIG. 2.

Problem 1 (Probstar Reachability of complex Le-CPS). Given a complex Le-CPS G= [symbol] V, E [symbol] and a probstar initial set of states of the system's plant X₀, compute the reachable set of the plant for T time steps, i.e., compute X={X₁, . . . , X_{T}}.

Problem 2 (Q² verification of complex Le-CPS). Given a complex Le-CPS G= [symbol] V, E [symbol] and a probstar initial set of states of the system's plant X₀, verify whether or not the state of the plant satisfies a safety property in T time steps and compute the satisfaction probability. Formally, one can verify if ∀x(0)∈X₀→x(k)|=S(x(k)), 0≤k≤T and compute the probabilities Pᵢ of the satisfaction at each time step P={P₀, P₁, . . . , P_{T} }, Pᵢ=P(x(i)|=S(x(i)) in which S is a linear predicate over the state variables x(k) defining the safety requirements of the system (|=denotes satisfaction).

Problem 3 (Counterexample Construction). Given a complex Le-CPS in Problem 2 with the initial state x(0)∈X₀, determine the complete probstar set of the initial conditions that make the system unsafe at step k.

### Probstar Algebra

Definition 2 (Probabilistic Star). A probabilistic star (or simply probstar) Θ is a tuple [symbol] c, V, N, P, l, u [symbol] where c∈ [symbol] ⁿ is the center, V=(ν₁, ν₂, . . . , νₘ is a set of m vectors in [symbol] ⁿ called basis vectors, P: [symbol] ^{m}→{T, ⊥} is a predicate, l and u are the lower-bound and upper-bound vectors of the predicate variables, which are random variables of a Gaussian distribution N. The basis vectors are arranged to form the probstar's n×m basis matrix. The set of states represented by the probstar is given as:

$$[ Θ ] = \{ x \vert x = c + {\sum }_{i = 1}^{m} ( {α}_{i} {v}_{i} ) , α = {[ {α}_{i} , … , {a}_{m} ]}^{T} ∼ N , P ( α ) C α \leq d , l [ i ] \leq {α}_{i} \leq u [ i ] , \} .$$

Both the tuple Θ and the set of states [Θ] are referred to as Θ.

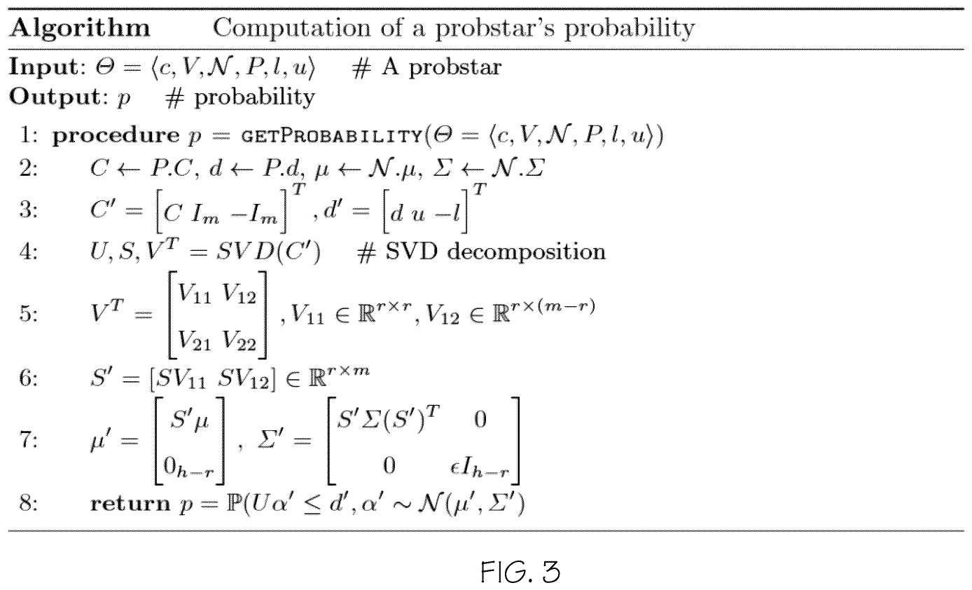

Definition 3 (Probability). Given a probstar Θ, the probability of the probstar is the probability of the predicate random variables α=[α₁, α₂, . . . , αₘ]^{T} satisfying its constraints and bounds, i.e., P(Θ)=P(Cα≤d∧l≤α≤u, α˜N(μ, Σ)). A probstar is an empty set if its probability is zero, i.e., P(Θ)=0. The algorithm of FIG. 3 computes the probability of a probstar.

Proposition 1 (Intersection). The intersection of a probstar Θ [symbol] [symbol] c, V, N, P, l, u [symbol] and a half-space H [symbol] {x|Hx≤g} is another probstar with the following characteristics:

$$\overline{Θ} = Θ ⋂ H = 〈 c , V , N , \overline{P} , l , u 〉 , \overline{P} = P ⋀ {P}^{′} , {P}^{′} ( α ) ( H \times V ) α \leq g - H \times c .$$

Proposition 2 (Affine Mapping). Given a probstar set Θ= [symbol] c, V, N, P, l, u [symbol] , an affine mapping of the probstar Θ with the mapping matrix W and offset vector b defined by Θ̅={y|y=Wx+b, x∈Θ} is another probstar with the following characteristics: Θ̅= [symbol] c⁻, V⁻, N, P, l, u [symbol] , c⁻=W+b, ν⁻={W_{ν}_{₁}, W_{ν}_{₂}, . . . , W_{ν}_{ₘ}}.

Reachable set dependency is key to achieving precise reachability analysis for complex Le-CPS, which is crucial in verification, as reachable sets that are too conservative may lead to unknown results. In the following, the definition of probstars dependency and the foundation of probstar algebra is presented, a tool for efficiently constructing precise reachable sets of all components in a complex Le-CPS.

Definition 4 (Probstars Dependency). Given a probstar Θ₁, and a compositional probstar

$${Θ}_{2} = {⋃}_{i = 1}^{N} {Θ}_{2}^{i}$$

(i.e., Θ₂ is a union of N individual probstars), Θ₂ depends on Θ₁, Θ₂<Θ₁ (or alternatively, Θ₁ is the ancestor of Θ₂, Θ₁>Θ₂), if the union of the predicates of individual probstars Θⁱ is the predicate of the probstar Θ₁, i.e., Θ₁.

$$P ( α ) = {⋃}_{i = 1}^{N} {Θ}_{2}^{i} . P ( α ) .$$

Definition 5 (Dependency Equivalent). Two probstars Θ₁ and Θ₂ are dependency equivalent, denoted as Θ₁ [symbol] [symbol] Θ₂, if and only if they share the same predicate, i.e., Θ₁·P(α)=Θ₂·P(α).

Proposition 3 (Dependency Preservation). A probstar Θ₁ and its affine map Θ₂ are dependency equivalent, i.e., Θ₂=W*Θ₁+b→Θ₂ [symbol] [symbol] Θ₁, where W is the mapping matrix and b is the offset vector.

Proposition 4 (Dependency in Piecewise Linear Transformation). Given a probstar Θ₁, let Θ₂=ƒ(Θ₁), where ƒ is a piecewise activation function, e.g., ReLU, LeakyReLU, and Satlin, then there is have Θ₂ is a dependent of Θ₁, i.e., Θ₂ [symbol] Θ₁.

Proposition 5 (Input-Output Dependency of Piecewise Network). Given a probstar Θ₁, let Θ₂ be the output of a piecewise neural network F with the input set Θ₁, i.e., Θ₂=F(Θ₁), there is Θ₂ which is a dependent of Θ₁, i.e., Θ₂ [symbol] Θ₁.

Proposition 6 (Transitivity of Dependency). Given three probstars Θ₁, Θ₂ and Θ₃, if Θ₁ [symbol] Θ₂ or Θ₁ [symbol] [symbol] Θ₂, and Θ₂ [symbol] Θ₃, then there is Θ₁ [symbol] Θ₃. Proposition 6 is a tool to trace the dependency between reachable sets of multiple components in a complex Le-CPS.

Proposition 7 (Composition of Dependent Probstars). The composition of two probstars Θ₁ and Θ₂ is a new probstar Θ=Θ₁∘Θ₂={(x₁, x₂)^{T}, x₁∈Θ₁, x₂∈Θ₂}. If Θ₂=UN Θⁱ [symbol] Θ₁ (Θ₂ is a dependent of Θ₁), then there is

$$Θ = {⋃}_{i = 1}^{N} {Θ}^{i} ,$$

where:

$${Θ}_{1} = 〈 {c}_{1} , {V}_{1} , N , {P}_{1} , {l}_{1} , {u}_{1} 〉 , {Θ}_{2}^{i} = 〈 {c}_{2}^{i} , {V}_{2}^{i} , N , {P}_{2}^{i} , {l}_{2}^{i} , {u}_{2}^{i} 〉 ,$$

$${Θ}^{i} = 〈 {( {c}_{1} , {c}_{i}^{2} )}^{T} , ( {V}_{1} , ; {V}_{2}^{i} ) , N , {P}_{2}^{i} , {l}_{2}^{i} , {u}_{2}^{i} 〉 .$$

Proposition 8 (Composition of Parallel Dependent Probstars). Given three probstars Θ₁, Θ₂, and Θ₃ in which

$${Θ}_{2} = {⋃}_{i = 1}^{N} {O}_{2}^{i} {Θ}_{1} and {Θ}_{3} = {⋃}_{j = 1}^{M} {O}_{3}^{j} {Θ}_{1} ,$$

then Θ₂ and Θ₃ are parallel dependents of Θ₁ and the composition of Θ₂ and Θ₃ is

$$Θ = {Θ}_{2} ∘ {Θ}_{3} = {( {x}_{2} , {x}_{3} )}^{T} , {x}_{2} ∈ {Θ}_{2} , {x}_{3} ∈ {Θ}_{3} = {⋃}_{k = 1}^{NM} {O}^{k} ,$$

$$where : k = ij , 1 \leq i \leq N , 1 \leq j \leq M ,$$

$${Θ}_{2}^{i} = 〈 {c}_{2}^{i} , {V}_{2}^{i} , N , {P}_{2}^{i} , {l}_{2}^{i} , {u}_{2}^{i} 〉 ,$$

$${Θ}_{3}^{j} = 〈 {c}_{3}^{j} , {V}_{3}^{j} , N , {P}_{3}^{j} , {l}_{3}^{j} , {u}_{3}^{j} 〉 ,$$

$${Θ}^{k} = 〈 {( {c}_{2}^{i} , {c}_{3}^{j} )}^{T} , ( {V}_{2}^{i} , {V}_{3}^{j} ) , N , {P}_{2}^{i} ∧ {P}_{3}^{j} , max ( {l}_{2}^{i} , {l}_{3}^{j} ) , min ( {u}_{2}^{i} , {u}_{3}^{j} ) 〉 .$$

In FIG. 2, the input set of network F₂ is the composition of a mapping set from the output set of network F₁ and a mapping set of the plant's reachable set. If the dependency relationship between these two sets is not known, a coarse input set for the network F₂ can be constructed, immediately leading to a very conservative output set which can be used to construct precise input sets to specific components in a complex Le-CPS.

Proposition 9 (Decomposition of a Probstar). A probstar Θ₁ can be de-composed into a union of probstars using its dependent predicates. Let

$${Θ}_{2} = {⋃}_{i = 1}^{N} {Θ}_{2}^{i} and {Θ}_{2} < {Θ}_{1} , then {Θ}_{1} = {⋃}_{i = 1}^{N} {Θ}_{1}^{i} ,$$

where:

$${Θ}_{1} = 〈 {c}_{1} , {V}_{1} , N , {P}_{1} , {l}_{1} , {u}_{1} 〉 , {Θ}_{2}^{1} = 〈 {c}_{2}^{1} , {V}_{2}^{i} , N , {P}_{2}^{i} , {l}_{2}^{i} , {u}_{2}^{i} 〉 ,$$

$${Θ}_{1}^{i} = 〈 {c}_{1} , {V}_{1} , N , {P}_{2}^{i} , {l}_{2}^{i} , {u}_{2}^{i} 〉 .$$

Proposition 10 (Minkowski Sum of Dependent Probstars). The Minkowski sum of two probstars Θ₁ and Θ₂ is a new probstar

$$Θ = {Θ}_{1} ⊕ {Θ}_{2} = \{ {x}_{1} + {x}_{2} , {x}_{1} ∈ {Θ}_{1} , {x}_{2} ∈ {Θ}_{2} \} .$$

$$If {Θ}_{2} = {⋃}_{i = 1}^{N} {Θ}_{2}^{i} {Θ}_{1} ( {Θ}_{2}$$

is a dependent of Θ₁), then there is

$${Θ}_{1} = {⋃}_{i = 1}^{N} {Θ}^{i} ,$$

where:

$${Θ}_{1} = 〈 {c}_{1} , {V}_{1} , N , {P}_{1} , {l}_{1} , {u}_{1} 〉 , {Θ}_{2}^{1} = 〈 {c}_{2}^{1} , {V}_{2}^{i} , N , {P}_{2}^{i} , {l}_{2}^{i} , {u}_{2}^{i} 〉 ,$$

### Reachability Analysis of Complex Le-CPS Using Probstar Algebra

This section addresses Problem 1 by developing an efficient algorithm to com-pute the reachable set of a complex Le-CPS using the proposed probstar algebra. As the information flows in a complex Le-CPS in a complicated manner, constructing a precise reachable set for the system can be challenging. Therefore, timing efficiency and conservativeness in constructing the reachable set can be important factors affecting the applicability of reachability methods in practical applications. As shown in Definition 1, reachability analysis of a complex Le-CPS is the computation of T sequential step-reachability graphs. Hence, the computation is how to efficiently compute the system's reachable set in a single step, which involves computing the reachable set for multiple components (e.g., plant and neural networks) in a specific time step k, given that it is known the initial conditions of the plant Xₖ. From the plant dynamics 1, there is: Xₖ₊₁=AXₖ⊕BUₖ, where ⊕ is the Minkowski sum operator. The control set Uₖ is computed by propagating the feedback set Yₖ=CXₖ through the networks. Therefore, if Uₖ is computed exactly, then it is a dependent of the initial state set Xₖ, i.e., Uₖ [symbol] Xₖ. Since affine mapping of a probstar preserves its predicate (Proposition 3), there is BUₖ [symbol] AXₖ. Consequently, the Minkowski sum of two sets AXₖ ⊕BUₖ, which is the next step reachable set of the system Xₖ₊₁, can be computed quickly and precisely using Proposition 10.

As analyzed above, the exact control set Uₖ is needed for efficient reachability analysis (i.e., fast and precise) of complex Le-CPS. So the question is how to compute the exact control set Uₖ under complex interaction between components. In this disclosure, it is assumed no loop between neural network components to reduce the complexity of the control set computation.

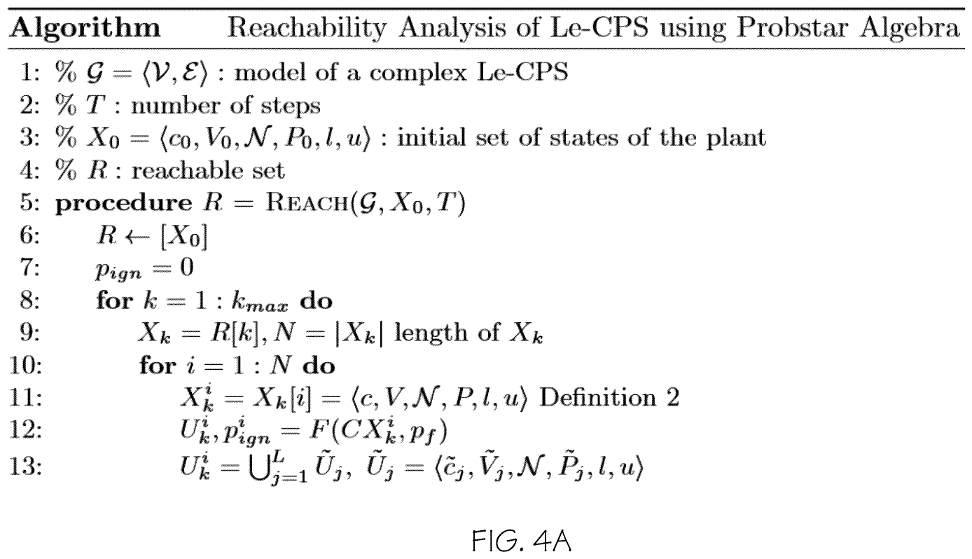

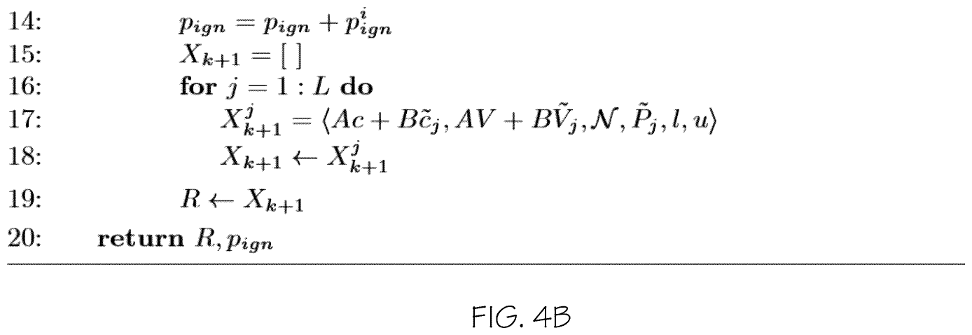

The inputs to the algorithm of FIG. 4 are the neural network controller, the plant's matrices A, B, and C, the number of steps to verify kₘₐₓ, the initial set of states of the plant X₀, and the filtering probability p_{ƒ}. The algorithm returns the reachable set R and the total probability of ignored input subsets p_{ign} in the analysis. If p_{ƒ}=0 is chosen, the reachability algorithm computes the exact reachable set of the system and returns p_{ign}=0. Otherwise, it computes the (under) approximate reachable set of the system with the estimated total probability of ignored input subsets p_{ign}>0. The probstar reachability algorithm works as follows. Initially, the initial set X₀ is put into the reachable set R and set the value of p_{ign}=0. At a timestep k, the state set Xₖ is loaded and length N is computed. For each state set

$${X}_{k}^{i} of {X}_{k} ,$$

the corresponding control set

$${U}_{k}^{i}$$

and the total probability of ignored input subsets

$${p}_{ign}^{i}$$

sing the probstar reachability algorithm are computed for ReLU FNN discussed by Tran, H. D., Choi, S., Okamoto, H., Hoxha, B., Fainekos, G., Prokhorov, D.: Quantitative verification for neural networks using probstars. In: Proceedings of the 26th ACM International Conference on Hybrid Systems: Computation and Control. pp. 1-12 (2023), which is incorporated by reference herein. It is noted that

$${U}_{k}^{i}$$

is a union of L probstars. The total probability of ignored input subsets p_{ign} is updated. For each control

$${\tilde{U}}_{j} in {U}_{k}^{i}$$

the corresponding reachable set for the next step

$${X}_{k + 1}^{j}$$

can be computed and saved. All L reachable sets of step k+1 can be put into the reachable set R. After looping over all steps, the constructed reachable set R and the total probability of ignored input subsets p_{ign} can be returned.

It can be seen that from a single initial set of the plant X₀, the network controller may produce multiple control sets U. In the worst case, the number of control sets |Uₖ| grows exponentially with the number of ReLU neurons in the controller. Therefore, the number of reachable sets of the plant states |Xₖ| increases exponentially over time. The following lemma describes the reachability complexity regarding the number of probstars in the plant's reachable sets.

Lemma 1. The worst-case complexity of the number of probstars in the reach-able set of a Le-CPS at step k, computed by the algorithm of FIG. 4 is O(2^{kN}), where N is the number of ReLU neurons in the network controller.

Proof. At the first step, from a single initial set X₀, the control set U=F(CX₀) contains 2^{N} probstars in the worst-case. Consequently, the worst-case number of probstars in the plant reachable set at the first step |X₁| is 2^{N}. At the second step, each set in X₁ produces 2^{N} control set Uₗ in the worst-case, which leads to 2^{N} probstar state sets X₂. Therefore, in the worst case, the total probstars of the plant reachable set at the second step is |X₂|=2^{N}×2^{N}=2^{2N}. By generalization, the worst-case number of probstars of the plant reachable set at step k is |Xₖ|=2^{N}×2^{N} . . . ×2^{N}=2^{kN}.

### Q² Verification of Le-CPS

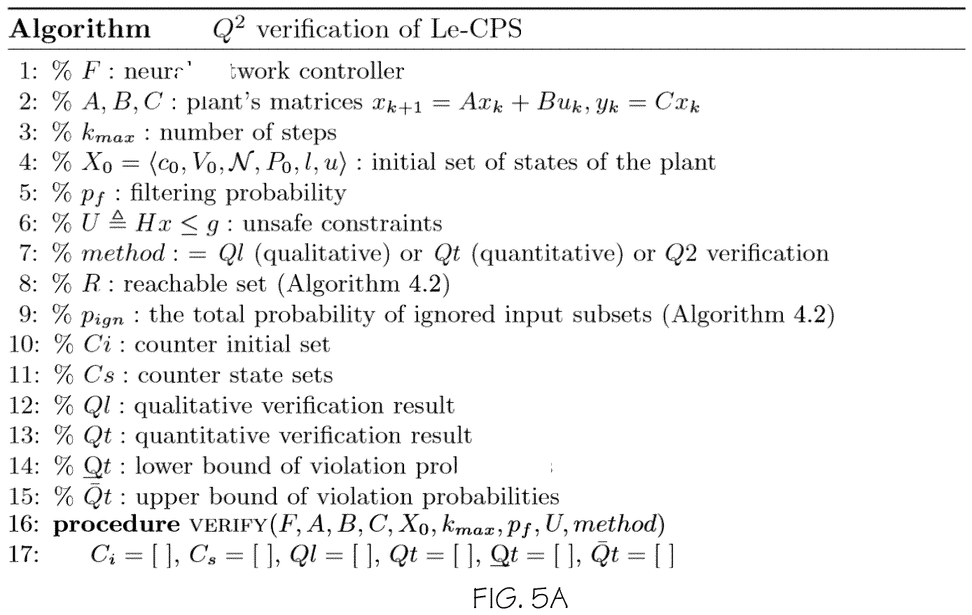

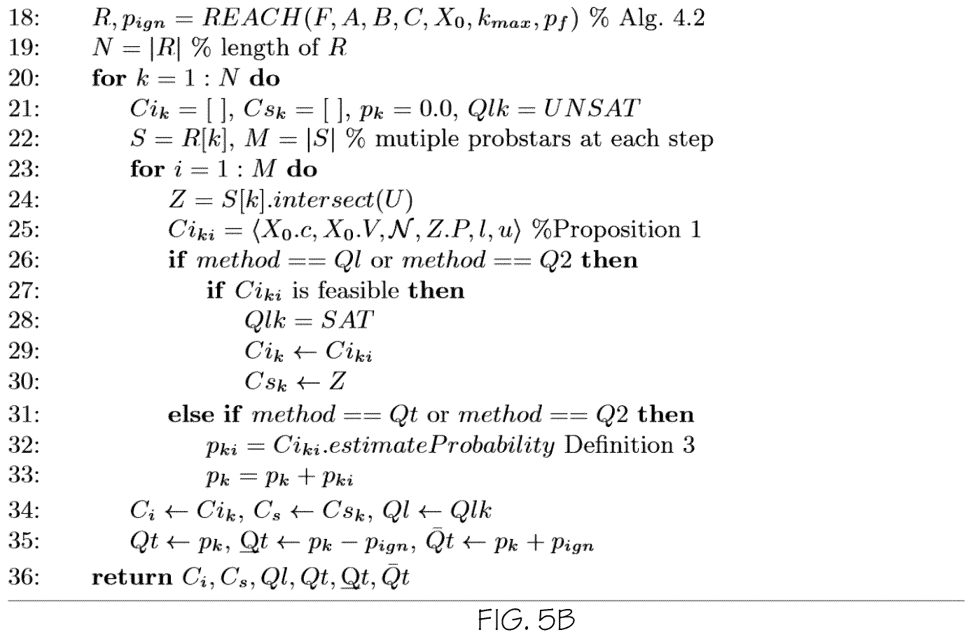

Based on probstar reachability, one can verify qualitatively and quantitatively the safety of Le-CPS. The algorithm of FIG. 5 describes the Q² verification method that takes the following inputs: the network F, the plant's matrices (A, B, C), the number of time steps kₘₐₓ, the filtering probability p_{ƒ}, the safety property specified as unsafe constraints U, and the option method to choose a verification strategy, i.e., qualitative or quantitative or Q². It returns counter initial sets Cᵢ, counter state sets Cₛ, qualitative verification results Ql, and quantitative verification results Qt, Qt, and Q̅t over time steps in which Qt and Q̅t are the estimations of the lower and upper bounds of violation probability when approximate reachability is used for computing the reachable set, i.e., p_{ƒ} >0.

The verification algorithm of FIG. 5 works as follows. All the returned verification results are initialized, i.e., Cₑ, Cₛ, Ql, Qt, Qt, and Q̅t as empty lists (line 17). Then, the reachable set of the system is computed using the probstar reachability algorithm (FIG. 4). Each time-step reachable set, i.e., Rₖ, is intersected with the unsafe constraints U (line 24). As the reachable set is a probstar, its intersection with half-space U creates another probstar Z. This intersection contains all constraints for the counter initial set that violates the safety property at this time step. Therefore, all counter initial sets for this time step Ciₖ can be constructed using the information from the initial state set X₀ and the predicate from the intersection Z.P (lines 24-25). If each counterinitial set Ciₖᵢ is feasible (line 27), SAT is added into Ql (qualitative result), Ciₖᵢ into Ciₖ, and Z into Csₖ (lines 28-30). One can also compute the probability pₖ of the counterexample input set Ciₖᵢ (line 32). Using this probability and the total probability of ignored input set in the analysis p_{ign} obtained from the reachability algorithm, the lower and upper bounds of the violation probability can be estimated at this step (line 35). The lower bound violation probability is pₖ−p_{ign}, where an optimistic assumption that all ignored input subsets will not violate the safety property is used. In contrast, the upper bound violation probability is pₖ+p_{ign}, where a pessimistic assumption that all ignored input subsets will violate the safety property is used. It is noted that if p_{ƒ}=0, then have p_{ign}=0 and Qt≡Qt≡Q̅t will be had. The following lemma illustrates the soundness and completeness of the Q² verification algorithm.

Lemma 2 (Soundness and Completeness). The Q² verification algorithm (FIG. 5) is sound and complete (exact verification) if exact reachability is used, i.e., no filtering p_{ƒ}=0. When approximate reachability is used (i.e., p_{ƒ}>0), the algorithm is sound but may not be complete (approximate verification).

Proof. When exact reachability is used, the constructed reachable set (a union of multiple probstars) of the Le-CPS contains all possible system states. Thanks to probstar probability (Proposition 1), the intersections of these probstar reachable sets with the safety property are also probstars whose total probability can be computed using the algorithm of FIG. 3. In other words, the exact verification obtains the total probability of safety violation. Simultaneously, it can also construct the complete set of counterexample initial conditions since the relationship between the initial conditions and the unsafe output sets is preserved via predicate variables (i.e., α). Therefore, the exact verification is sound and complete.

When approximate reachability is used, the Q² verification algorithm only uses a subset of the exact reachable set of the system to estimate the lower and upper bounds of the violation probability under pessimistic and optimistic views. However, these bounds are sound estimations that bound the exact violation probability because they consider all ignored reachable sets in verification. Nevertheless, the approximate verification cannot construct the complete set of counterexample initial conditions. It may construct a subset of the counterexample initial conditions from the subset of the exact reachable set used in verification. If that is the case, the approximate verification is complete. Otherwise, the approximate verification is incomplete.

Handling unbounded set of initial conditions. The Q² verification algorithm for Le-CPS works for bounded set of initial conditions, i.e., the initial set of states of the plant X₀ is a truncated Gaussian distribution. In practice, the initial set of states of the plant is usually a Gaussian distribution, which is unbounded. Since computing the exact control set of the ReLU controller from unbounded input set is generally intractable, computing the exact reachable set for Le-CPS with unbounded set of initial conditions is impossible in general. However, the Q² verification algorithm can still provide quantitative guarantee for Le-CPS for entire unbounded initial condition space using optimistic and pessimistic assumptions in verification. Let X̅0 be the tail of the initial condition Gaussian distribution. One has X̅0 ∩X₀= [symbol] ⁿ and P(X₀)+P(X̅0)=1, where n is the dimension of the plant. Let Qt and Q̅t are the lower and upper bounds of violation probability obtained from the algorithm of FIG. 5. Then the lower and upper bounds for violation probability of Le-CPS for entire unbounded initial condition space are Qₘᵢₙ=Qt and Qₘₐₓ=Q̅t+1−P(X₀). Qₘᵢₙ is the lower bound of violation probability of Le-CPS for entire initial condition space with an optimistic assumption that the tail of the initial condition does not violate safety property. Qₘₐₓ is the upper bound of violation probability of Le-CPS for entire initial condition space with a pessimistic assumption that entire the tail violates safety property.

### Evaluation

The proposed Q² verification algorithm was implemented using StarV, described by Tran, H. D., Choi, S., Okamoto, H., Hoxha, B., Fainekos, G., Prokhorov, D.: Quantitative verification for neural networks using probstars. In: Proceedings of the 26th ACM International Conference on Hybrid Systems: Computation and Control. pp. 1-12 (2023) incorporated by reference, a new tool for Q² verification of DNNs and Le-CPS. The experiments were executed on an iMAC 3.8 GHz 8-Core Intel Core i7, 128 GB memory with virtual 64-bit Ubuntu 20.04.4 LTS system. The proposed verification algorithm is evaluated in terms of timing performance, conservativeness, and scalability using the learning-based adaptive cruise control (ACC) system and the advanced emergency braking system (AEBS).

### Q² Verification of Learning-Based Systems

The learning-based ACC system consists of an ego (following) vehicle and a lead vehicle in which the ego one has a radar sensor to measure the distance to the lead vehicle in the same lane, Dᵣ and the relative velocity of the lead vehicle, Vᵣ. In speed control mode, the ego vehicle travels at a user-set speed Vₛₑₜ, =30 (m/s), and in spacing control mode, it is required to maintain a safe distance from the lead vehicle, D_{safe}. Three neural networks with N layers (N=3, 5, 7) of 20 neurons per layer with ReLU activation functions are trained to control the ego vehicle with a control period of 0.1 seconds. The linear dynamics of the system are as follows.

$${\dot{x}}_{lead} ( t ) = {v}_{lead} ( t ) , {\dot{v}}_{lead} ( t ) = {γ}_{lead} , \\ {\dot{γ}}_{lead} ( t ) = - 2 {γ}_{lead} ( t ) + 2 {a}_{lead} , {\dot{x}}_{ego} ( t ) = {v}_{ego} ( t ) , {\dot{v}}_{ego} ( t ) = {γ}_{ego} , {\dot{γ}}_{e g o} ( t ) = - 2 {γ}_{ego} ( t ) + 2 {a}_{ego} ,$$

where x_{lead}(x_{ego}), ν_{lead}(ν_{ego}) and γ_{lead}(γ_{ego}) are the position, velocity and acceleration of the lead (ego) vehicle respectively. α_{lead}(α_{ego}) is the acceleration control input applied to the lead (ego) vehicle. The corresponding linear continuous model is discretized using a zero-order hold on the inputs with a sample time of 0.1 seconds (i.e., the control period) to obtain a discrete linear model of the plant.

Safety Scenarios. When the ego vehicle is in the speed control mode and at a safe distance, the lead vehicle driver suddenly decelerates with α_{lead}=−5 (m²/s) to reduce the speed. The neural network controller is required to decelerate the ego vehicle to maintain a safe distance between the two cars in at least 5 seconds. The safety property is as follows:

$${D}_{r} = {x}_{lead} - {x}_{ego} \geq {D}_{safe} = {D}_{default} + {T}_{gap} \times {v}_{ego} ,$$

where T_{gap}=1.4 seconds and D_{default}=10 meters. The system's safety is investigated under the following initial conditions: x_{lead}(0)∈[90, 92], ν_{lead}(0)∈[20, 21], γ_{lead}(0)=γ_{ego}(0)=0, ν_{ego}(0)∈[30, 30.5], and x_{ego}∈[30, 31].

Probabilistic initial set. To perform Q² verification for the ACC system, a probstar initial set of states is created for the analysis. Let lb, ub be the lower and upper bound vectors of the system's initial states, i.e., lb≤x[0]≤ub, x[0]∈R⁷ (one virtual state (x₇) is introduced to obtain a linear model for the system to analyze). Then, the mean of the Gaussian distribution is chosen as μ=(lb+ub)/2. The standard deviation of the distribution σ=[σ₁, σ₂, . . . , σ₇]^{T} is chosen such that μ+α×σ=ub→σ=(ub−μ)/α, where α is a positive coefficient. When α increases, the probability of the inputs lying between their lower and upper bounds of interest increases. In this example, α=2.5 is chosen. The variance of the distribution is

$$\sum = diag ( {σ}_{1}^{2} , {σ}_{2}^{2} , … , {σ}_{7}^{2} ) ,$$

where diag stand for a diagonal matrix.

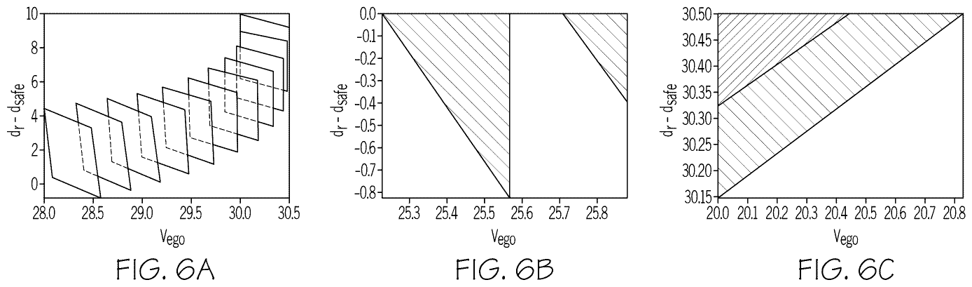

Intuitive verification using reachable set visualization. Our approach can compute and visualize the exact and approximate probabilistic reachable sets, counter initial sets, and counter state sets of the system for many time steps. FIG. 6 illustrates the probstar reachable sets for 10 time steps of Dᵣ−D_{safe} vs. ν_{ego}, the counter state (output) sets Cₛ, and the counter initial sets (Cᵢ) of the ACC system controlled by the 5×20-network. It can be seen from the figure that at steps 9 and 10, there are small areas (FIGS. 6A and 6B) in which the relative distance Dᵣ is smaller than the safe distance D_{safe} (since Dᵣ−D_{safe}<0). Therefore, the ACC system violates its safety property in these time steps. The initial set of states that violate the safety property is depicted in FIG. 6C. Quantitatively, it also can see that even the system is unsafe. However, this violation has a very small probability (FIG. 6B) as only tiny regions in the reachable set violate the safety rule. Interestingly, from FIG. 6A, it can be seen that the ego car does reduce its velocity to maintain its safety, i.e., the 5×20-neural network controller works but is not as safe as expected.

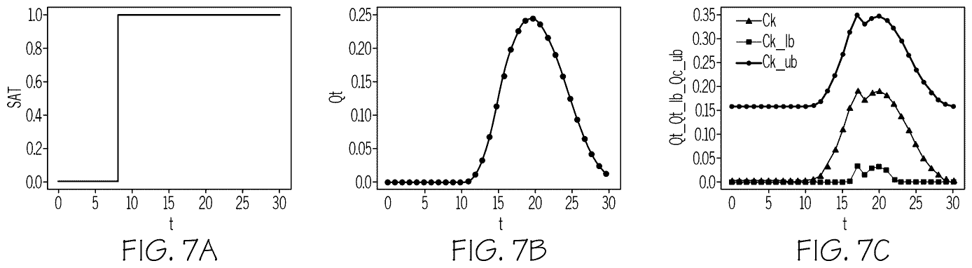

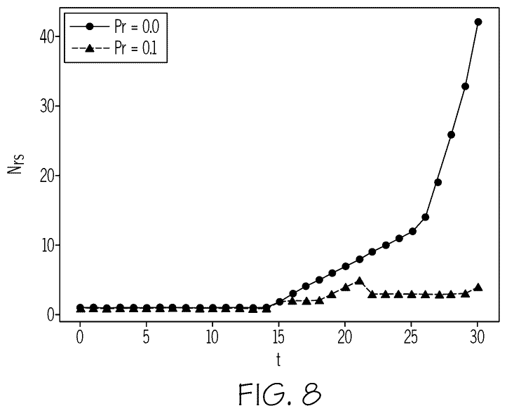

Q² verification results. This approach can simultaneously produce qualitative and quantitative verification results. FIG. 7A presents the exact qualitative results using the exact reachability scheme, i.e., p_{ƒ}=0, for verification. In this figure, SAT=1 means that the system violates the safety property, i.e., unsafe. It can clearly be seen that the system violates its safety property from the 9^{th} time steps. FIG. 7B shows the exact quantitative verification results. It can be seen that the system violates its safety property with the highest probability of ≈0.23 at the 20^{th} time steps. After that, the violation probability reduces quickly. FIG. 7B illustrates the estimated violation probability Qt and its lower and upper bounds Qt_{lb} and Qt_{ub} when using the approximate reachability for verification with filtering probability p_{ƒ}=0.1. It can be seen that the lower and upper bounds of the estimated violation probability (FIG. 7C) are quite conservative compared to the exact quantitative verification (FIG. 7B) because some reachable sets are ignored in the verification. When p_{ƒ} is increased, the number of reachable sets will be reduced. The effect of increasing filtering probability in verification is illustrated in FIG. 8.

Timing performance and scalability. The Table 1 describes the timing performance and scalability of this approach via verifying the ACC system with different neural network controllers.

TABLE 1

| p_{f} | Network | VT(s) | Nᵣₛ | p_{ignored} |
|---|---|---|---|---|
| 0 | 3 × 20 | 27.3011 | 576 | 0 |
| 0 | 5 × 20 | 2.75313 | 42 | 0 |
| 0 | 7 × 20 | 338.911 | 2418 | 0 |
| 0.02 | 3 × 20 | 13.7319 | 8 | 0.311501 |
| 0.02 | 5 × 20 | 11.6417 | 6 | 0.0108472 |
| 0.02 | 7 × 20 | 68.2326 | 3 | 0.832571 |
| 0.04 | 3 × 20 | 8.3262 | 6 | 0.368269 |
| 0.04 | 5 × 20 | 9.9012 | 5 | 0.0313438 |
| 0.04 | 7 × 20 | 33.539 | 1 | 0.907504 |

Table 1: Timing performance and scalability analysis in which V T is the verification time in seconds, Nᵣₛ is number of reachable sets in the final step (step 30), p_{ignored} is the total probability of ignored initial subsets in verification, and p_{ƒ} is the filtering probability.

The table shows that the approach herein can verify the ACC systems with different neural network controller sizes with fairly reasonable verification time. It also scales with the network sizes. One can see that verifying the system with a large neural network controller, e.g., 7×20-network, tends to be more time-consuming. Interestingly, this is not the case for the smallest 3×20-network. It can be seen that using the 3×20- and 7×20-networks to control the ACC system leads to significantly more reachable sets in the final step than using the 5×20-network. This leads to higher verification times. This shows that the 5×20 network does not have diverse behaviors as the others (so it may be the best controller). The table again shows that increasing the filtering probability pr may help reduce verification time significantly. However, it may lead to conservative results as the total probability of ignored initial sets will be increased. Depending on the applications, users can choose a reasonable value for the filtering probability to simultaneously achieve good timing performance, scalability, and verification results.

### Q² Verification of Advanced Emergency Braking System

FIG. 8 describes the architecture of the AEBS and its Matlab Simulink model for safety verification. As shown in the figure, the host car is equipped with a perception component to automatically detect obstacles on the road and a reinforcement learning (RL) based controller to control the car's brake. The controller's goal is to stop the car to avoid a collision and prevent an early stopping scenario, which means the vehicle should stop within a safe and close region to the obstacle, i.e., l≤dₛₜₒₚ≤L. In this study, l=0.5 meters and L=2.0 meters is chosen. The plant of the braking system is described as follows:

$${x}_{k + 1} = {Ax}_{k} + {Bu}_{k} , {y}_{k} = {Cx}_{k} ,$$

where xₖ=[dₖ νₖ]^{T} is the state vector, including the distance dₖ and the car velocity νₖ at step k; uₖ is the control input, which is the acceleration applied to the plant: yₖ is the output; and the coefficient matrices A, B, C are given below.

$$A = [ \begin{matrix}1 & Δ t \\ 0 & 1\end{matrix} ] , B = [ \begin{matrix}0 \\ Δ t\end{matrix} ] , C = [ \begin{matrix}1 & 0 \\ 0 & 1\end{matrix} ]$$

where Δt=1/15 is the simulation time step. It is noted that the reinforcement controller output is the braking force Tₖ, which is transformed into the acceleration uₖ using a ReLU neural network with 80 neurons. It can be seen that the AEBS model is more complex than the considered system model in FIG. 1 due to the two neural networks involved in the feedback loop. However, the verification algorithm can still be extended to verify this system. The system's safety is verified under the following initial conditions (Table 2) for more than T time steps where T≥30, which is described in Tran, H. D., Cai, F., Diego, M. L., Musau, P., Johnson, T. T., Koutsoukos, X.: Safety verification of cyber-physical systems with reinforcement learning control. ACM Transactions on Embedded Computing Systems (TECS) 18(5s), 1-22 (2019), incorporated by reference herein.

TABLE 2

| | ${X}_{0}^{1}$ | ${X}_{0}^{2}$ | ${X}_{0}^{3}$ | ${X}_{0}^{4}$ |
|---|---|---|---|---|
| d₀ | [97, 97.5] | [90, 90.5] | [60, 60.5] | [50, 50.5] |
| y₀ | [25.2, 25.5] | [27, 27.2] | [30.2, 30.4] | [32, 32.2] |

The present disclosure is directed to a Q² verification approach for Le-CPS with ReLU network controllers controlling linear plant model. The approach can provide simultaneously qualitative and quantitative verification results in an acceptable computation time. The trade-off between timing performance, scalability, and conservativeness can be adjusted by tuning the filtering probability in verification. It is shown the applicability and advantages of the approach via verification of an ACC system controlled by a neural network.

Only the verification of reach-avoid property is considered. In practice, there are more expressive safety properties that involve temporal behaviors of the system over time, like ones described by signal temporal logic (STL). Q² verification for temporal properties of Le-CPS is significantly challenging, which requires a novel logic defined on probabilistic reachable set signal (instead of the traditional real-value signals like STL). Associated with this logic are advanced Q² verification algorithms to efficiently verify such complex temporal properties.

### Temporal Logic Verification

Probstar Temporal Logic (ProbStarTL), a formalism enabling quantitative verification of temporal properties of learning-enabled systems (LES) is introduced. Verification involving the computation of reachable sets of LES, ProbStarTL is defined on a (bounded-time) ProbStar signal (or ProbStar trace), a sequence of discrete, timed probabilistic star reachable sets. The logic has a well-defined syntax and quantitative semantics and supports two basic temporal operators: always (□) and finally (⋄). Since ProbStarTL is defined only over finite timing intervals, the until (U) operator is evaluated using the equivalent formula composed of the always (□) and finally (⋄) operators. To construct ProbStar traces, probstar reachability algorithms are developed, focusing on closed-loop LES reachability. This disclosure investigates exact and approximate probstar reachability algorithms for closed-loop LES with a ReLU feedforward neural network controlling a discrete linear plant model. Our approach can be extended for verifying temporal behaviors of networks handling time-series data, such as recurrent neural networks.

Verifying the temporal behaviors of an LES involves checking if its ProbStar traces satisfy a user-defined ProbStar specification, which can be done in two steps. First, the user-defined ProbStar specification is transformed into an abstract disjunctive normal form (DNF), the disjunction of time-abstracted linear constraints on the system's states. The abstract DNF formula is then realized on a specific ProbStar trace to obtain a computable DNF that exact or approximate verification algorithms can verify. The exact verification algorithm, while computationally expensive, provides sound and complete verification results with exact satisfaction probability. In contrast, the approximate verification algorithm, less expensive than the exact one, estimates only the lower and upper bounds of satisfaction probability.

The ProbStar temporal logic verification framework may be implemented in StarV, a verification tool for LES, using Python. The proposed framework can be evaluated using a learning-based adaptive cruise control system (Le-ACC). The experimental results show that the approach has successfully verified multiple temporal properties of the Le-ACC system (under a reasonable amount of time) that the state-of-the-art cannot verify. Via extensive experiments, the timing performance and the conservativeness of the results with two metrics, including conservativeness and constitution values are analyzed. The conservativeness value shows how good the verification results are. The constitution value indicates when the probability of satisfaction can be achieved. The verification complexity is analyzed and the strategies to reduce the complexity and increase the scalability of the approach are discussed. From the analysis it can be learned that verification complexity depends significantly on the system's characteristics, e.g., the neural network controllers and initial conditions, the complexity of the temporal properties, and the number of time steps involved.

Contributions. To summarize, the following contributions are made:
(i) Verification Framework of Temporal Properties for LES.
(ii) Propose the ProbStarTL temporal logic for LES, with a procedure for computation of satisfaction probability.
(iii) Depth-first Search Algorithm for exact (sound and complete) and approximate (sound) reachability analysis for constructing reachable set traces of closed-loop LES for verification.
(iv) A new quantitative verification algorithm that can compute the exact and approximate satisfaction probability of temporal properties.
(v) A verification tool, StarV, was developed using Python and provided for in the Le-ACC case study.

### Preliminaries

In the following, the notation [symbol] is used for the reals and [symbol] is used for the natural numbers (including zero).

### Probabilistic Star

Definition 1 (Probabilistic Star). A probabilistic star (or simply probstar) Θ is a tuple [symbol] c, V, N, P, l, u [symbol] where c∈ [symbol] ⁿ is the center, V={ν₁, ν₂, . . . , νₘ} is a set of m vectors in [symbol] ⁿ called basis vectors, P: [symbol] ^{m}→{T, ⊥} is a predicate, l and u are the lower-bound and upper-bound vectors of the predicate variables, which are random variables of a Gaussian distribution N. The basis vectors are arranged to form the probstar's n×m basis matrix. The set of states represented by the probstar is given as:

$$[ Θ ] = \{ x \vert x = c + {\sum }_{i = 1}^{m} ( {α}_{i} {v}_{i} ) , α = {[ {α}_{1} , … , {α}_{m} ]}^{T} ∼ N , P ( α ) {=}^{Δ} C α \leq d , l [ i ] \leq {α}_{i} \leq u [ i ] , \} .$$

Both the tuple Θ and the set of states [symbol] Θ [symbol] are referred to as Θ.

Definition 2 (Probability). Given a probstar Θ, the probability of the probstar is the probability of the predicate random variables α=[α₁, α₂, . . . , αₘ]^{T} satisfying its constraints and bounds, i.e., [symbol] (Θ)= [symbol] (Cα≤d∧l≤α≤u, α˜N(μ, Σ)), where μ and Σ are the mean and the covariance of the predicate random variables, respectively. A probstar is an empty set if its probability is zero, i.e., [symbol] (Θ)=0. See Tran, H. D., Choi, S., Okamoto, H., Hoxha, B., Fainekos, G., Prokhorov, D.: Quantitative verification for neural networks using probstars. In: Proceedings of the 26th ACM International Conference on Hybrid Systems: Computation and Control. pp. 1-12 (2023), incorporated herein by reference.

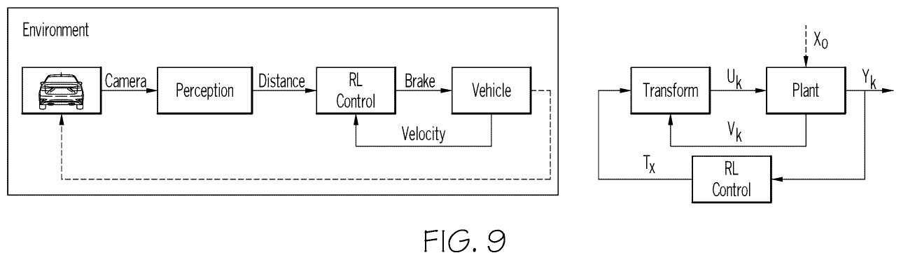

A closed-loop Learning Enabled System (LES) which comprises a plant with linear dynamics and a feedforward neural network controller is shown in FIG. 9. The plant x(t+1)=Ax(t)+Bu(t) is a discrete time linear system with state x∈Rⁿ. The controller F is a ReLU feedforward neural network (FNN), processing inputs through layers with weights W_{l,t-1}, biases bₗ, and ReLU activation functions to produce output u=F(Cx). The output of each neuron is given by

$${v}_{i}^{out} = ReLU ( {\sum }_{j = 1}^{n} {w}_{ij} {v}_{j}^{in} {b}_{i} ) ,$$

where νⁱⁿ is the input (output from the previous layer). In the following, an LES is considered to be the tuple S= [symbol] A, B, C, F [symbol] . Given a set of initial conditions X₀ and a maximum time T, then for every x(0)∈X₀ and for t∈ [symbol] =[0, T−1]⊂N, a trajectory (signal) of LES is the solution of the usual iteration x(t+1)=Ax(t)+BF(Cx(t)).

Definition 3 (ProbStar Signal of LES). Given an LES S= [symbol] A, B, C, F [symbol] , a time T and a ProbStar set of initial conditions X₀, the sequence R=(X₀, X₁, X₂, . . . , X_{T}) is called a bounded-time ProbStar signal of the LES if

$$∀ t ∈ \cdot {X}_{t + 1} = A {X}_{t} ⊕ BF ( {CX}_{t} ) .$$

Here, ⊕ is the Minkowski sum operation. The following results.

Proposition 1. For any t∈ [symbol] and x(0)∈ [symbol] X₀ [symbol] , there is x(t)∈ [symbol] Xₜ [symbol] . Conversely, for any \tilde{x}∈ [symbol] Xₜ [symbol] , there exists x(0)∈ [symbol] X₀ [symbol] such that x(t)=\tilde{x}.

### Discrete-Time Temporal Logics for State Sequences

Many properties of interest for LES can be expressed through temporal logics over LES trajectories. Several variants of temporal logics have been developed which depend on whether (1) the trajectories are continuous time or discrete time, (2) the specifications are formulated over predicates or atomic propositions, (3) the properties are spatial and/or timed, and so on. In the following, for more information on temporal logics in the context of Cyber-Physical Systems (CPS), refer to the survey chapter of Bartocci, E., Deshmukh, J., Donz'e, A., Fainekos, G., Maler, O., Nickovic, D., Sankaranarayanan, S.: Specification-based monitoring of cyber-physical systems: A survey on theory, tools and applications. In: Lectures on Runtime Verification—Introductory and Advanced Topics, LNCS, vol. 10457, pp. 128-168. Springer (2018).

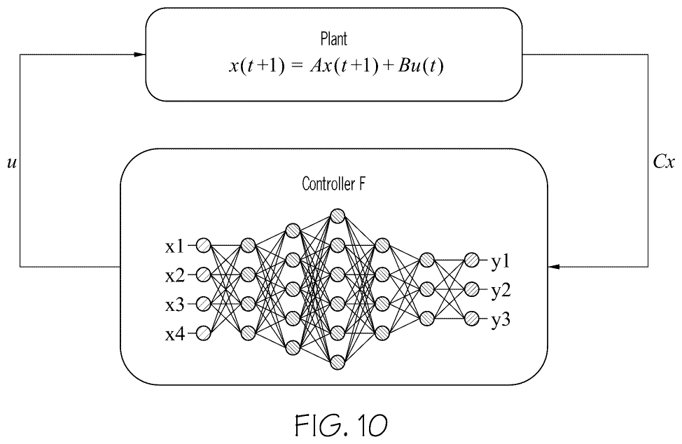

The systems of interest, i.e., FIG. 10, produce discrete-time trajectories (signals) which can also be represented as state sequences up to a horizon T. The state (sample) timestamps can be ignored since it is assumed a constant sampling rate Δt. Given an LES state sequence x: [symbol] → [symbol] ⁿ, where [symbol] ={0, 1, 2, . . . , T}⊂N, properties are expressed over the signal values x(t) through arithmetic expressions. A logic that can express such requirements is Signal Temporal Logic (STL) with discrete time semantics. However, discrete time semantics and bounded time intervals on the temporal operators reduce STL to Linear Temporal Logic (LTL) with syntactic sugar to capture the timing bounds (if the STL predicates are abstracted by atomic propositions). Therefore, the specification language is actually a regular language and it could be described by regular expressions (RE) or finite automata (FA). Since FA is not used in this disclosure and conjunction in RE is not standard, the STL notation and semantics is used primarily for notational convenience.

Let μ_{p,q} be an atomic predicate defined as a linear inequality constraint on state variables x at time t with the canonical form:

$$( x , t ) \vert = {μ}_{p , q} iff {p}^{T} x ( t ) + q \geq 0 ,$$

where |= stands for satisfies, and p, q are some parameter vectors. In the later chapters, depending on the context, also denote the set of states x that satisfy p^{T} x+q≥0 by [symbol] μ_{p,q} [symbol] (or just μ_{p,q} depending on the context).

Definition 4 (DT-STL Syntax). The discrete-time STL syntax is:

$$φ := {μ}_{p , q} \vert ¬ φ \vert φ ⋀ φ \vert ○φ \vert {◻}_{I} φ ,$$

where ∧ is the and Boolean operator, ◯ is the next time operator, and □ₗ is the always temporal operator over a bounded time interval I⊂N.

The standard Boolean and temporal operators can be derived using the usual equivalences. For example, or (∨) is defined as φ₁∨φ₂≡¬(¬φ₁∧¬φ₂) and eventually (⋄₁) as ⋄ₗφ≡¬□ₗ¬φ. While the until operator (U) is not considered in Def. 4, when the semantics are defined over discrete and bounded time, then until can be defined as a disjunction of a finite number of always and eventually operators, e.g.,

$${ϕ}_{1} {U}_{[ m , n ]} {ϕ}_{2} ≡ {⋁}_{i = m}^{n} ( )$$

or using a finite number of compositions of the next operator.

Definition 5 (DT-STL Semantics). Given a discrete time signal x, the DT-STL semantics are defined by the following equivalences:

$$( x , t ) \vert = {μ}_{p , q} ↔ {p}^{T} x ( t ) + q \geq 0 ,$$

$$( x , t ) \vert = ¬ φ ↔ ( x , t ) \vert = φ$$

$$( x , t ) \vert = {φ}_{1} ⋀ {φ}_{2} ↔ ( x , t ) \vert = {φ}_{1} ⋀ ( x , t ) \vert = {φ}_{2}$$

$$( x , t ) \vert = ○φ ↔ ( x , t + 1 ) \vert = φ$$

$$( x , t ) \vert = {◻}_{[ t 1 , t 2 ]} φ ↔ ∀ t ∈ [ t 1 , t 2 ] . ( x , t ) \vert = φ$$

where |= stands for “does not satisfy.”

Without loss of generality, it is assumed that the signal length (i.e., T) is longer than the time horizon needed to evaluate an STL formula φ, described by Maler, O., Nickovic, D.: Monitoring temporal properties of continuous signals. In: Proceedings of FORMATS-FTRTFT. LNCS, vol. 3253, pp. 152-166 (2004), incorporated herein by reference. If this is not the case, then alternative semantics can be defined where the formula horizon is permitted to be longer than the signal length, described by Fainekos, G. E., Pappas, G. J.: Robustness of temporal logic specifications. In: Formal Approaches to Testing and Runtime Verification. LNCS, vol. 4262, pp. 178-192. Springer (2006), incorporated herein by reference.

### Probabilistic DT-STL Satisfiability for LES

Problem Statement. In this disclosure, the goal is to compute the probability that an LES S over a time domain T and with initial conditions in a ProbStar set X₀, satisfies a DT-STL formula φ. In other words, the following is computed

$$P [ ( x , 0 ) \vert = φ \vert x ( 0 ) ∈ {X}_{0} ] .$$

Toward that goal, efficient probabilistic star reachability algorithms for LES's ProbStar signals under DT-STL specifications are developed.

In order to compute probability, discussed by Brix, C., Bak, S., Liu, C., Johnson, T. T.: The fourth international verification of neural networks competition (vnn-comp 2023): Summary and results, arXiv preprint arXiv:2312.16760 (2023), incorporated herein by reference, it is needed to measure how many trajectories starting from the initial ProbStar set X₀ satisfy the STL requirement. At the very least, such a computation needs to capture how many trajectories satisfy an atomic predicate at each point in time. In other words, given an atomic predicate μ_{p,q} and some time t, it is needed to be able to assess P [(x, t)|=μ_{p,q}|x(0)∈ [symbol] X₀ [symbol] ]. Due to Proposition 1, this is equivalent to P[ [symbol] X₀ [symbol] ]∩ [symbol] μ_{p,q} [symbol] ]. Moving on to temporal operators, a formula like □ₜ₁,t₂μ_{p,q} would require satisfaction of the predicate μ_{p,q} for all times between t₁ and t₂, i.e., P[(x, t₁)|=μ_{p,q}, . . . , (x, t₂)|=μ_{p,q}|x(0)∈ [symbol] X₀ [symbol] ]. Again, this is equivalent to P[ [symbol] Xₜ1 [symbol] ∩ [symbol] μ_{p,q} [symbol] , . . . , [symbol] Xₜ2 [symbol] ∩ [symbol] μ_{p,q} [symbol] ]. Note that since Xₜ is a ProbStar, its intersection with an (atomic) predicate, i.e., Xₜ∧μ, is also a ProbStar (Proposition 3) whose probability can be computed by the algorithm of FIG. 10.

In order to generalize the above intuition to arbitrary DT-STL formulas, it is needed to define a recursion that collects the constraints that must be satisfied over time. This recursive definition may be referred to as ProbStarTL since it resembles DT-STL semantics over ProbStar signals.

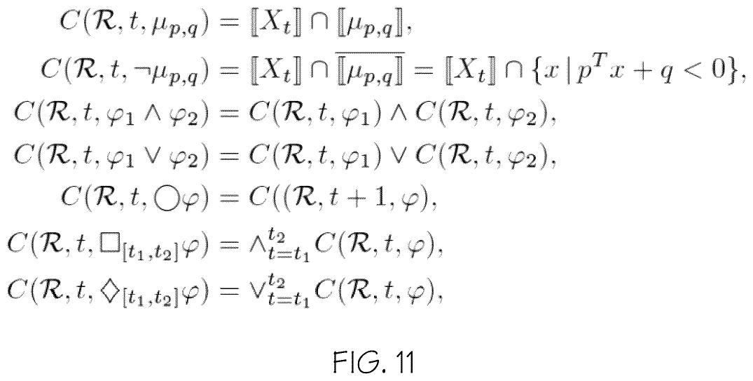

Definition 6 (ProbStarTL). Given a ProbStar signal R=(X₀, X₁, . . . , X_{T}) and a DT-STL formula φ in Negation Normal Form (NNF), the constraints over time that characterize the trajectories x that satisfy φ can be derived recursively based on the structure of the formula φ shown in FIG. 11, where S̅ indicates the complement of a set S.

Def. 6 assumes that the DT-STL formula is in Negation Normal Form (NNF). In NNF, negations (¬) can only appear in front of atomic predicates. Any DT-STL formula can be converted into NNF by using the usual equivalences of Boolean and temporal operators and pushing the negation operators in front of the atomic predicates. It is assumed that a rewriting function nnf (φ) converts a DT-STL formula φ in NNF.

By definition, there is P[(x, 0)|=φ|x(0)∈ [symbol] X₀ [symbol] ]=P[C(R, t, nnf (φ))]. Also notice that P[(x, 0)|=φ|x(0)∈ [symbol] X₀ [symbol] ]+P[(x, 0)|=φ|x(0)∈ [symbol] X₀ [symbol] ]=1.

To assess specification satisfaction, it is necessary to convert the specification, along with the ProbStar signal, into a verifiable Disjunctive Normal Form (DNF). This transformation explicitly outlines the evolved constraints required for satisfaction. The DNF of the ProbStarTL specification φ has the form:

$$φ = {⋁}_{i} ( {⋀}_{j} {μ}_{j} ) ,$$

where μⱼ is an atomic predicate. The above DNF is called abstract DNF (ADNF), which is not yet verifiable as it does not involve the ProbStar signal on which the specification is reasoned. To verify the specification, a realization process is performed to transform its abstract DNF into a computable DNF (CDNF). A CDNF of a specification is of the form:

$$φ = {⋁}_{i} {S}_{i} ,$$

where Sᵢ is a Probstar.

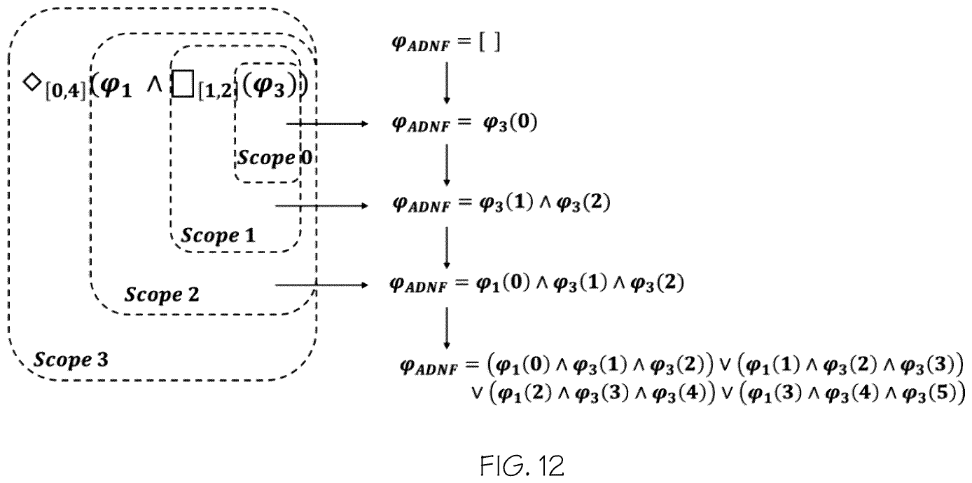

Disjunctive normal form derivation algorithm. The automatic derivation of CDNF of a specification p on a ProbStar signal R consists of two main steps. The first step obtains the specification's ADNF while the second step derives its CDNF via realizing the obtained ADNF on the ProbStar signal. Initially, the ADNF is an empty list. It will be expanded from the innermost scope to the outermost scope (from the right to the left) of the specification. The scopes of a specification can be determined using parenthesis ( ) and logic or temporal operators. FIG. 12 describes the scopes of a specification and its ADNF automatic derivation.

After obtaining the ADNF of a specification, a realization process is performed to obtain the CDNF. The realization process replaces the abstract constraints with timing information, e.g., φ₁(t=2), in the ADNF by the real constraints using the reachable sets in the considered ProbStar signal. The realization of an abstract constraint μ(t):p^{T} x(t)+q≥0 on a ProbStar signal R=(X₀, X₁, . . . , Xₜ, . . . ), denoted as μ(t)_{R}, is the new predicate created from intersecting the t^{th} ProbStar reachable set Xₜ∈R with the abstract constraint. Mathematically, there is:

$${X}_{t} ⋀ μ ( t ) = {X}_{t}^{′} = \{ {c}^{′} + α {v}^{′} , {P}^{′} ( α ) : {C}^{′} α \leq {d}^{′} , α ∈ N \} , \to {μ ( t )}_{R} = {P}^{′} ( α ) : {C}^{′} α \leq d .$$

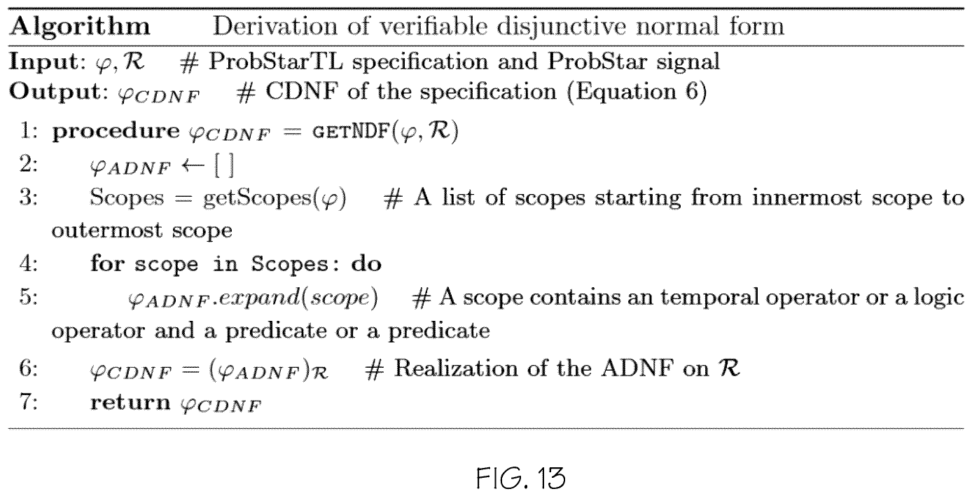

The algorithm of FIG. 13 summarizes the steps for automatic derivation of a CNDF of a ProbStarTL specification. It is started by initializing the ADNF of the specification (line 2). Then, one gets all scopes of the specification ordered from the innermost scope to the outermost scope (line 3). Each scope contains a temporal operator (with timing information) or a logic operator with an associated predicate or a predicate. All the scopes are looped through and expand the ADNF in these scopes (lines 4-5). Finally, the realization process is performed on the final ADNF to get the CDNF of the specification (line 6) and return the result (line 7). To quantify the satisfaction of a specification φ on a ProbStar signal R, the probability of its associated CDNF needs computed using the following lemma.

Lemma 1 (Probability of a CDNF). Let

$${φ}_{CDNF} = {V}_{i = 1}^{n} {S}_{i}$$

be the CDNF of a specification φ on a ProbStar signal R, then the exact probability [symbol] _{exact} and its estimated lower bound [symbol] ₗ probabilities of the CDNF are as follows:

$${ℙ}_{exact} = {\sum }_{i = 1}^{n} ℙ ( {S}_{i} ) + {( - 1 )}^{1} {\sum }_{i \neq j} ℙ ( {S}_{i} ⋀ {S}_{j} ) + {( - 1 )}^{2} {\sum }_{i \neq j \neq k} ℙ ( {S}_{i} ⋀ {S}_{j} ⋀ {S}_{k} ) + ⋯ + {( - 1 )}^{n - 1} ℙ ( {S}_{i} ⋀ {S}_{j} ⋀ {S}_{n} {ℙ}_{exact} \geq {ℙ}_{l} = max ( ℙ ( {S}_{1} ) , ℙ ( {S}_{2} ) , … , ℙ ( {S}_{n} ) ) .$$

Lemma 2 (Complexity in computing a CDNF's probability). Let N_{exact} and Nₑₛₜᵢₘₐₜₑ be the number of Probstar probability computations involved in computing the exact probability of

$${φ}_{CDNF} = {⋁}_{i = 1}^{n} {S}_{i} ,$$

and estimating its lower bound. Then there is:

$${N}_{exact} = {\sum }_{k = 1}^{n} {C}_{n}^{k} = {2}^{n} - 1 , where {C}_{n}^{k}$$

is the number of k-combinations of n elements, and Nₑₛₜᵢₘₐₜₑ=n.

### Quantitative Verification of LES

### Probabilistic Star Reachability Analysis of LES

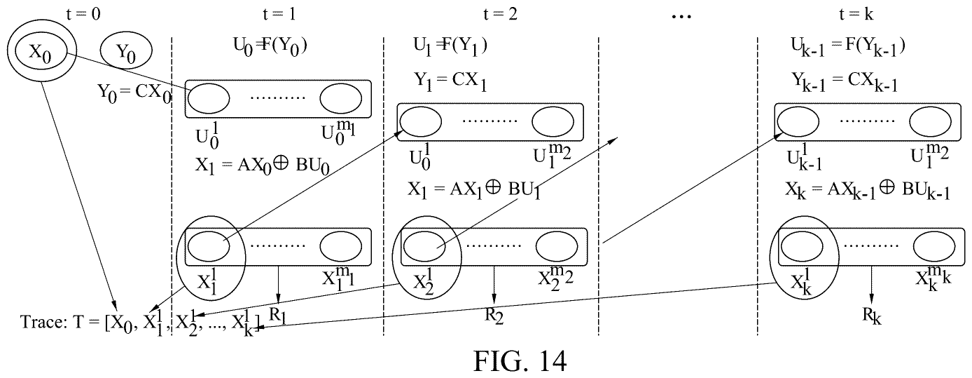

The k-step reachability analysis for LES, illustrated in FIG. 14, works as follows: At t=0, the plant's state and output sets are X₀ [symbol] c₀, V₀, N, P₀, l, u [symbol] and Y₀=CX₀, respectively. At t=1, the neural network controller computes the control set from the feedback output set: U₀=F(Y₀). As F is a ReLU FNN, the exact control set is a union of m₁ ProbStars

$${U}_{0} = \{ {U}_{0}^{1} , {U}_{0}^{2} , , {U}_{0}^{{m}_{1}} \} , {U}_{0}^{i} = 〈 {\tilde{c}}_{i} , {\tilde{V}}_{i} , N , {\tilde{P}}_{i} , l , 𝓊 〉 .$$

Note that the normal distribution N and the lower and upper bound vectors l and u do not change in the analysis. The reachable set of the plant is the Minkowski sum of the mapped initial state AX₀ and the mapped control input set BU₀, denoted as X₁=AX₀⊕BU₀. It is observed that the first step reachable set X₁ is also a union of multiple ProbStars, represented as

$${X}_{1} = {X}_{1}^{1} , {X}_{1}^{2} , … , {X}_{1}^{{m}_{1}} .$$

Similar to the star set approach discussed at Tran, H. D., Cai, F., Diego, M. L., Musau, P., Johnson, T. T., Koutsoukos, X.: Safety verification of cyber-physical systems with reinforcement learning control. ACM Transactions on Embedded Computing Systems (TECS) 18(5s), 1-22 (2019), incorporated by reference, the state set X₀, and the control set U₀ are defined based on a unique set of random predicate variables. Therefore, the i^{th} probstar in the first-step reachable set

$${X}_{1}^{i} = 〈 {Ac}_{0} + {Bc}_{i}^{∼} , {AV}_{0} + {BV}_{i}^{∼} , N , {P}_{i}^{∼} , l , u 〉 .$$

To compute the next-step reachable set, i.e., X₂, the output Y₁=CX₁ is fed back to the controller and repeat the same computation procedure.

Depth-first search (DFS) reachability algorithm. One can see that at any time step, due to the ReLU network controller, a single plant's state set can lead to multiple reachable sets in the next time step. This means that from a signal initial set of state X0, a LES can produce multiple ProbStar signals (reachable set traces) [symbol] ={T₁, T₂, . . . , T_{M}}. A k-step ProbStar signal is defined as

$${T}_{i} = {Y}_{0} \to {X}_{1}^{i} \to {X}_{2}^{i} \to … \to {X}_{k}^{i} in which {X}_{j}^{i} ,$$

is produced by

$${X}_{j - 1}^{i} , i \leq j \leq k .$$

To construct the ProbStar signals for LES, the reachability analysis needs to be performed in a depth-first search manner in which the production chains of reachable sets are kept track of. FIG. 14 illustrates the first ProbStar signal produced by performing reachability analysis forwardly for k steps using the first reachable set X¹, 1≤j≤k in each time step. By doing that, X₀ produces

$${X}_{1}^{1} ( {X}_{0} \to {X}_{1}^{1} ) , and$$

$${X}_{1}^{1} produces {X}_{2}^{1} ,$$

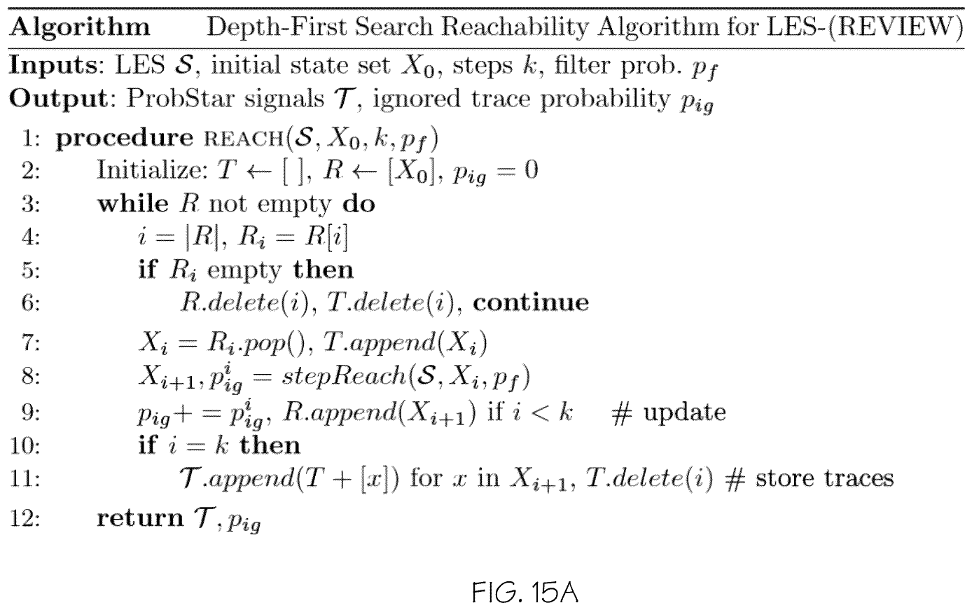

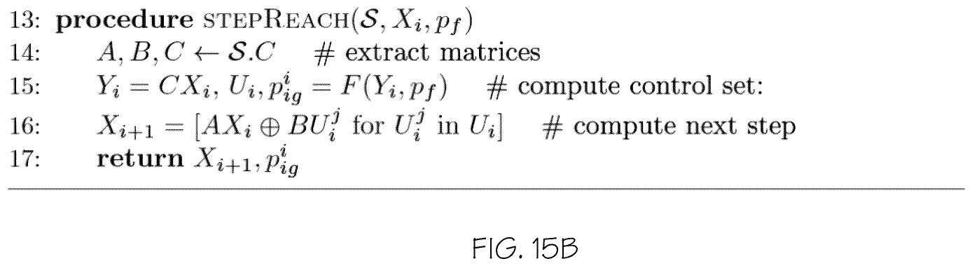

and so on. The algorithm of FIGS. 15A and 15B presents the DFS reachability algorithm for LES. The inputs to the algorithm are the LES S= [symbol] F, M [symbol] , the plant's initial state set X₀, the number of time steps k, and the filtering probability p_{ƒ}. The filtering probability p_{ƒ} is used to filter out all the traces in the analysis whose probabilities are smaller than p_{ƒ}. The algorithm returns the list of all ProbStar signals [symbol] and the total probabilities of ignored ProbStar signals in the analysis p_{ig}. The algorithm works as follows. The trace T is initialized as an empty list, the remaining sets R as X₀, and the total probability of ignored traces p_{ig} as zeros (line 2). A while loop is used to perform forward reachability analysis with remaining sets R and only stop when R is empty. Note that the length of R, denoted as i=|R|, is also the current considering time step (line 4). At the current time step i, one gets the intermediate sets of this step Rᵢ=R[i](line 4). If Rᵢ is empty, the empty Rᵢ is deleted, reset the trace T to the previous trace Tᵢ₋₁ (line 5-6), and start the forward reachability analysis with step i−1 with a new set Xᵢ₋₁ the remaining sets in this step Rᵢ₋₁. Otherwise, the first set Xᵢ in Rᵢ is obtained, added to the trace T (line 7), and the reachable set for the next step is computed using stepReach subprocedure (line 8). The stepReach procedure produces the reachable set of the next time step Xᵢ₊₁ and the total probability of ignored reachable sets p_{ig}. If the next step i+1 is the final time step k, i.e., i+1==k (line 10), then all the sets in Xᵢ₊₁ are the leaves of the trace T. Therefore, all traces are constructed with these leaves and added to the list of traces [symbol] (line 11) and then the last set in the current trace is deleted (to move forward later). If the next step i+1 is not the final step k, one adds the constructed set Xᵢ₊₁ into the intermediate set R (line 9) and keep moving forward.

### Qualitative and Quantitative Verification Algorithm

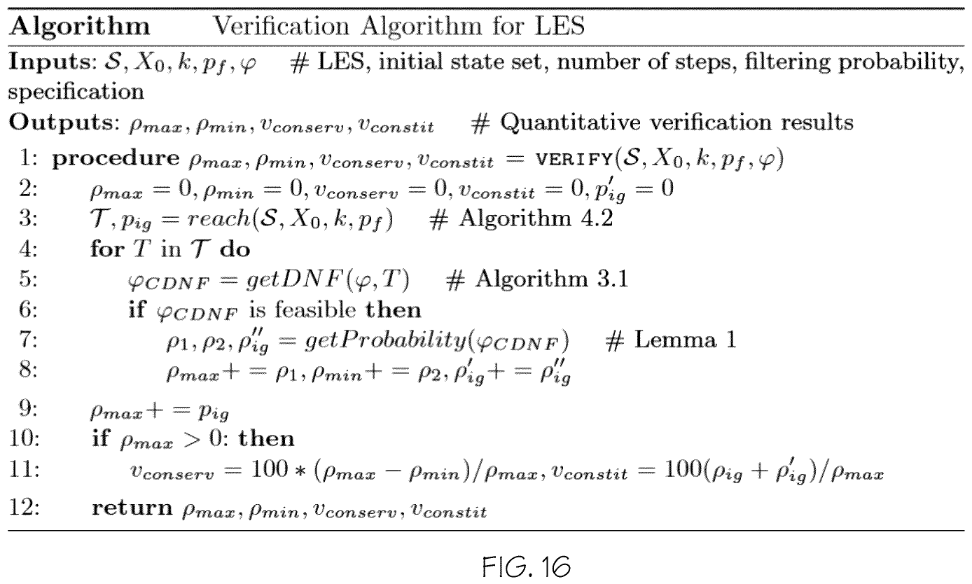

After constructing the ProbStar signals of LES, these signals can be verified against a temporal specification written using ProbStarTL. The Algorithm of FIG. 16 describes the quantitative verification for LES used herein. The inputs to the algorithm are the considering LES S, its initial set of states X₀, number of time steps k, filtering probability p_{ƒ}, and the specification φ. The algorithm returns upper (ρₘₐₓ) and lower (ρₘᵢₙ) bounds of satisfaction probability, the conservativeness value ν_{conserv}, and the constitution value ν_{constit}, defined in the following:

$${v}_{conserv} = \{ \begin{matrix}100 * \frac{{ρ}_{max} - {ρ}_{min}}{{ρ}_{max}} , & if {ρ}_{max} > 0 \\ 0 , & otherwise\end{matrix} , {v}_{constit} = 100 * \frac{{ρ}_{i , g}}{{ρ}_{max}} .$$

The conservativeness value ν_{conserv} shows how tight the estimation range of satisfaction probability is. The higher the conservativeness value, the more conservative the estimation is. The conservativeness value is zero if ρₘₐₓ=ρₘᵢₙ or ρₘₐₓ=0.0. The constitution value ν_{constit} shows how much the total probability of the ignored traces and CDNFs contributes to the estimation. If ν_{constit}=0, there are no ignored traces or CDNFs in verification there for the ρₘₐₓ is the exact satisfaction property. If ν_{constit}=100%, the estimation of ρₘₐₓ=ρ_{ignored}, i.e., the estimation is entirely based on the optimistic assumption that all ignored traces and CDNFs satisfy the property. The algorithm works as follows. All verification results are initialized as zeros in line 2. Using the Algorithm of FIGS. 15A and 15B, all ProbStar signals [symbol] are constructed and the probability of ignored traces p_{ig} are computed (line 3). All signals (traces) are looped over in the list [symbol] (line 4). For each signal T in [symbol] , the CDNF φ_{CDNF} of the specification φ is obtained on T (line 5). The feasibility of the obtained CDNF φ_{CDNF} is checked. If feasible, the lower and upper bounds of satisfaction probability for trace T (ρ_{T}) are computed using its CDNF (lines 7 and 8). If the CDNF is too large, i.e., its length is larger than 11; its corresponding trace T will be ignored too with the ignored probability p′. The upper bound of satisfaction probability ρ₁ from computing the probability of this CDNF will be the ignored probability p″_{ig}. The total probability bounds and the total probability of ignored traces are advanced in line 8. After looping through all traces, the upper bound of the satisfaction probability pₘₐₓ is advanced by p_{ig} (the total probability of ignored traces in reachability). The conservativeness and constitution values are calculated in lines 10 and 11 and all verification results are returned in line 12.

### Evaluation

The probabilistic star temporal logic verification approach was implemented in StarV, a tool for qualitative and quantitative verification of DNNs and Le-CPS written in Python. The experiments were executed on an iMAC 3.8 GHz 8-Core Intell Core i7, 128 GB memory with virtual 64-bit Ubuntu 20.04.4 LTS system. The verification approach was evaluated using a learning-based adaptive cruise control (ACC) system.

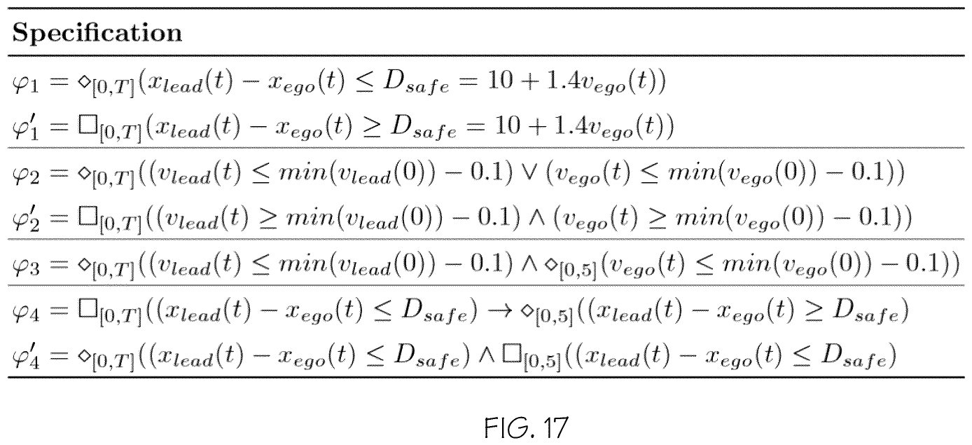

Scenarios and properties of interest. When the ego vehicle is in the speed control mode and at a safe distance, the lead vehicle driver suddenly decelerates with a lead=−5 (m²/s) to reduce the speed. The properties of interest are given in the table of FIG. 17. For property φ₁, the probability of the system being unsafe is computed at some steps between 0 and T, i.e., Dr≤Dsafe. Conversely, for property

$${φ}_{1}^{′} ,$$

the probability of the system being always safe between 0 and T is computed. Note that

$${ρ}_{{φ}_{1}} + {ρ}_{{φ}_{1}^{′}} = {P}_{{X}_{0}} .$$

For property φ₂, the probability that the lead or ego cars reduce their speed to avoid collision is computed. The property

$${φ}_{2}^{′}$$

is opposite to the property φ₂. For property φ₃, it is verified that eventually, in T steps, when the lead car reduces its speed, the ego car also reduces its speed within five steps. Property φ₄ specifies the expected reactive behavior requiring that always the case that between 0 and T, if two cars are in an unsafe distance, eventually, two cars will be in a safe distance again within five steps. Opposite to property φ₄, property

$${φ}_{4}^{′}$$

states that eventually, between 0 and T, there is the case that when two cars are under an unsafe distance, they are always in the same unsafe condition for the next five steps.

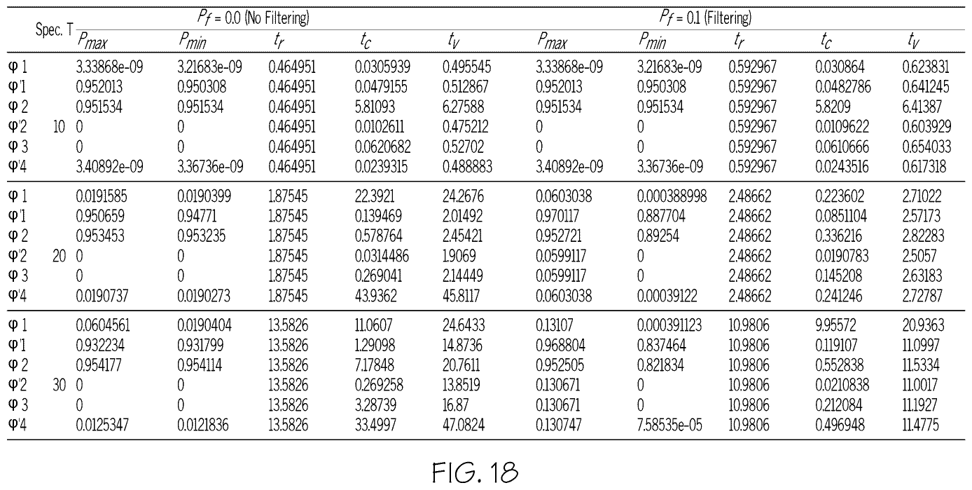

Verification results. The table of FIG. 18 describes the verification results of Le-ACC with the network controller N_{5×20} (i.e., 5 layers, 20 neurons per layer) for different properties with and without filtering under different time steps T. All properties can be verified within a reasonable verification time except for φ₄, where there was a memory problem due to its large abstract disjunctive formula. However, as mentioned above, property

$${φ}_{4}^{′}$$

is an opposite property of φ₄. Therefore, φ₄ can be verified via verifying

$${φ}_{4}^{′} .$$

The verification results include the estimation of the lower and upper bounds of the probability that the system satisfies a property, the times for constructing reachable set traces, checking satisfaction, and the total verification time. The verification results show that lower ρmin and upper ρmax bounds of the probability of property satisfaction vary for different time ranges, i.e., [0, T]. Notably, although the system has a high probability of satisfying the safety requirement (e.g., 0.95134 for T=10), i.e.,

$${φ}_{1}^{′} ,$$

there is still the case with a small probability (e.g., 3.3386e−09 for T=10) that the system is unsafe, i.e., φ1 is satisfied. From verifying properties φ₂ and

$${φ}_{2}^{′} ,$$

it can be seen that there is a zero probability that both cars do not reduce their speed. For property φ₃, it can be seen that there is a zero probability that when the lead car reduces its speed in five-time steps, the ego car also reduces its speed to avoid a collision. This shows that the network controller output does not make the ego car react fast enough (in five steps). The results for verifying

$${φ}_{4}^{′}$$

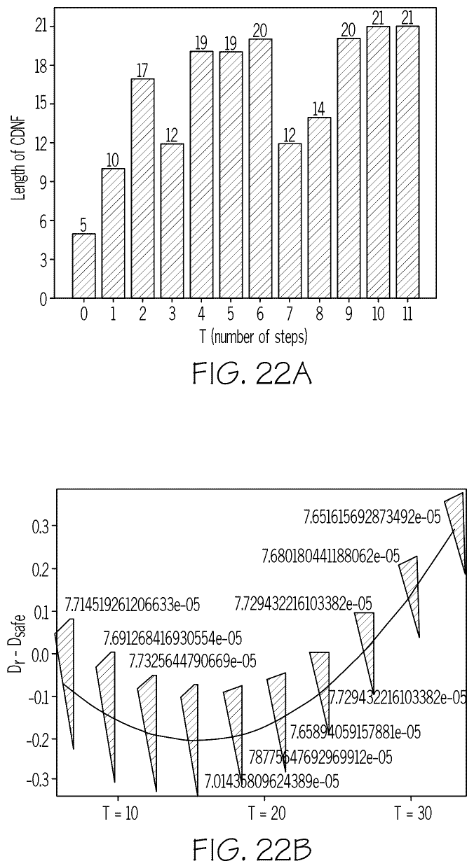

show that there will be the case with a small probability (e.g., 0.0125 for T=30) that the expected reactive behavior of the system is not satisfied, i.e., the system cannot recover to a safe condition in 5 steps after it goes into the unsafe condition. FIG. 22B depicts a reachable set trace showing this system behavior. One can see from the figure that when the system goes into an unsafe condition, i.e., Dᵣ≤D_{safe}, it stays there for the next five steps.

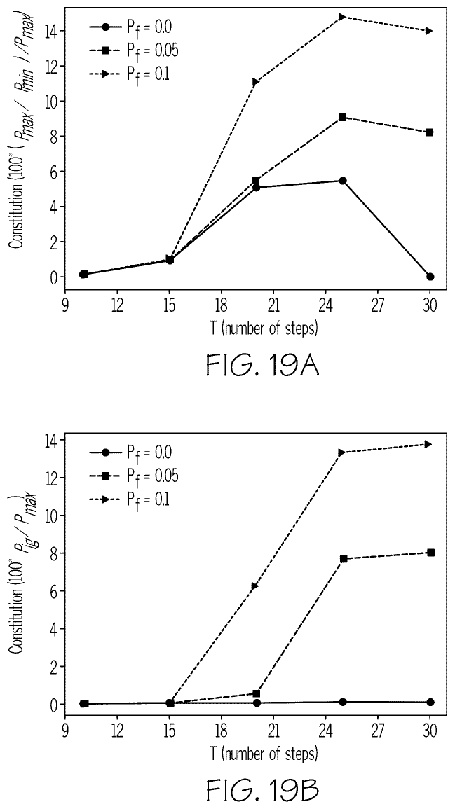

Conservativeness and exact probability of satisfaction. The described verification approach provides the estimation of the lower and upper bounds of the probability of satisfaction. Therefore, it is crucial for users to know how conservative the estimation is and when the exact satisfaction probability can be obtained. The estimation's conservativeness comes from two sources: 1) some traces with very small probabilities are ignored in verification, and 2) some very large CD-NFs are ignored in the exact probability computation (Lemma 1). As these traces and CDNFs are ignored, the upper bound of the probability of satisfaction can be optimistically estimated by assuming that all ignored traces and CDNFs will satisfy the considering property. If there are no traces and CDNFs ignored in verification, then the upper bound ρₘₐₓ is the exact probability of satisfaction. One can see that the conservativeness value ν_{conserv} shows how tight the estimation range is. The higher the conservativeness value, the more conservative the estimation is. The conservativeness value is zero when whether ρₘₐₓ=ρₘᵢₙ or ρₘₐₓ=0.0. In both cases, the exact satisfaction probability can be achieved. The constitution value ν_{constit} shows how much the total probability of the ignored traces and CDNFs contributes to the estimation. If ν_{constit}=0, there are no ignored traces or CDNFs in verification there for the ρₘₐₓ is the exact satisfaction property. If ν_{constit}=100%, the estimation of ρₘₐₓ=ρ_{ignored}, i.e., the estimation is entirely based on the optimistic assumption. From the table of FIG. 18, the conservativeness value can be computed to evaluate how good the verification results are. FIG. 19A shows the conservativeness of verification results for property

$${φ}_{1}^{′}$$

in different time steps. It can be seen that without filtering out traces in analysis, i.e., p_{ƒ}=0 in the algorithm of FIG. 16, the verification results for

$${φ}_{1}^{′}$$

are good (smaller 6%). Notably, when choosing T=10 and T=30, the conservativeness values are zeros, which means ρₘₐₓ is the exact satisfaction probability. One can see from the figure that increasing the filtering probability p_{ƒ} increases the conservativeness of verification results. For example, for T=30, if p_{ƒ}=0.1 is chosen, the conservatives of verification results is ≈14% compared to ≈8% if p_{ƒ}=0.05 and 0% if p_{ƒ}=0. Note that the conservativeness value does not wholly show when an exact satisfaction probability can be obtained. The constitution value V_{constit} is used to know that. FIG. 18B depicts the constitution values of

$${φ}_{1}^{′}$$

verification. It can be seen that with p_{ƒ}=0, the constitution values for all T are zeros, which means the upper bound ρₘₐₓ in the verification results are the exact satisfaction probabilities (even though the conservativeness values V_{conserv} are larger than zero for some T). It can also be seen that the ignored traces and CDNFs contribute ≈14% and 8% in satisfaction probability estimation (ρₘₐₓ) for T=30.

Timing performance analysis. As shown in the table of FIG. 18, the total verification time tᵥ varies for different properties and selected numbers of time steps T. Both reachability time tᵣ and checking time tᵣ can dominate the total verification time. This domination also varies for different properties and the selected number of time steps. For example, for T=30, in

$${φ}_{2}^{′}$$

verification, reachability time dominates the verification (13.58 s vs. 0.269 s), while in

$${φ}_{4}^{′}$$

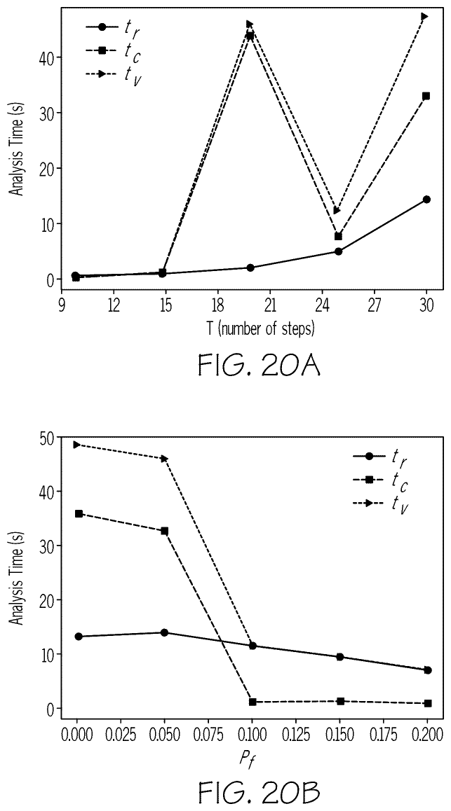

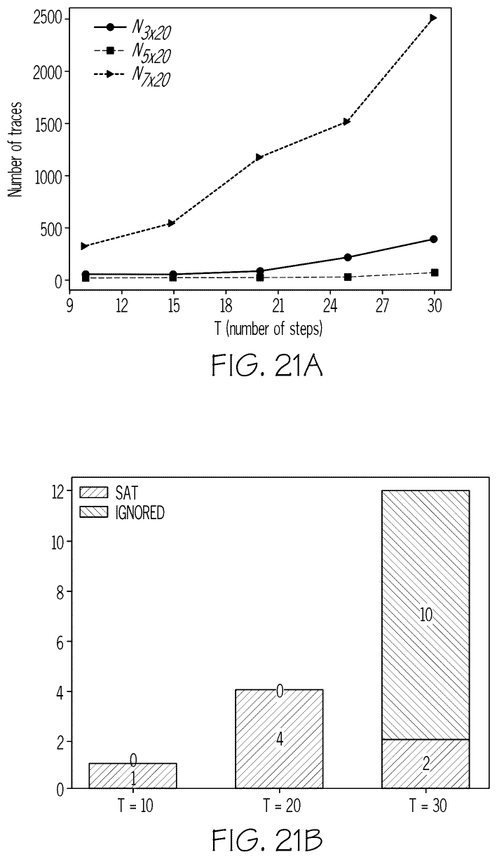

verification, the checking time is the most significant one (33.49 s vs. 13.58 s). Another example is, in φ₁ verification, the checking time is the significant one (22.39 s vs. 1.875 s) for T=20, but the reachability time is the dominant one (0.46 s vs. 0.03 s) for T=10. It can be seen from the table of FIG. 20A that the reachability time increases when the number of time steps Tin verification is increased. This is because the number of traces increases along with the growth of the time steps involved in the analysis (this fact is shown in FIG. 21A). However, the total verification time fluctuates significantly due to the fluctuation in the checking time. It can be seen from FIG. 20A that the checking time for T=20 is larger than the ones for T=25 and T=30. Therefore, it is significantly challenging to create appropriate metrics to assess the timing performance in quantitative verification for temporal properties. FIG. 19B shows that by applying filtering, the verification time can be reduced significantly. However, the cost is the conservativeness of verification results (as analyzed above).

Verification complexity and scalability. In the approach described herein, the verification complexity depends on 1) the number of traces involved in verification, 2) the number of CDNFs after realizing the specification on these traces, and 3) the lengths of obtained CDNFs. The number of traces of a LES varies significantly for different numbers of time steps, networks, and initial conditions. Different neural network controllers may behave very differently on the same initial conditions, even if trained with the same data set. FIG. 21A shows the number of traces of three trained network controllers N_{3×20}, N_{5×20}, and N_{7×20} for Le-ACC. Notably, a smaller network does not necessarily lead to a smaller number of traces. For example, the controller N_{3×20} produces 352 traces at T=30, compared to 44 traces produced by the controller N_{5×20}. This means verifying the Le-ACC with N_{3×20} is even more complex and time-consuming than verifying it with the bigger controller, i.e., N_{5×10}. The biggest controller N₇ₓ₂₀ behaves very complicatedly as it creates 2488 traces at T=30, which makes the verification tasks even more challenging and time-consuming. Therefore, to reduce verification complexity and improve scalability, filtering, and parallel computation can be important techniques. The second factor affecting the verification complexity is the number of CDNFs. Not every trace in the reachable traces will create a CDNF after the realization. The number of CDNFs for a property may vary significantly for different numbers of time steps. A smaller number of time steps does not guarantee a smaller number of CDNFs, which makes the total verification fluctuate for different time ranges. The last factor affecting the verification complexity is the lengths of CDNFs. From Lemma 2, computing the exact probability of a CDNF with the length of n, requires 2ⁿ−1 ProbStar probability estimation. Therefore, to reduce the verification complexity and increase the scalability, large CDNFs can be ignored in verification, and the total probability of ignored CDNFs is used to estimate the upper bound of satisfaction with an optimistic view that all ignored CDNFs will satisfy the property. In the implementation described herein, nₘₐₓ=11 is the maximum length allowed for computing the exact satisfaction probability. FIG. 22A shows the lengths of CDNFs produced in

$${φ}_{4}^{′}$$

verification with T=30. It can be seen that among 44 traces produced in the reachability analysis process (FIG. 21A), 12 CDNFs are constructed in the realization process in which 10 of them have lengths larger than 11, which are ignored in exact probability computation. FIG. 21B describes the number of CDNFs produced and ignored in verifying φ₄ for different numbers of time steps T and p_{ƒ}=0.0 (i.e., no filtering). It can be seen that the number of constructed CDNFs for T=10, T=20, and T=30 are 1, 4, and 12, respectively. There are no CDNFs ignored in exact probability computation for T=10 and T=20. Therefore, the ρₘₐₓ for

$${φ}_{4}^{′}$$

(FIG. 18) are the exact satisfaction probabilities in these cases (≈3.4e−09 for T=10 and ≈0.019 for T=20). Meanwhile, for T=30, the ρₘₐₓ (≈0.0125) for φ′ is a conservative estimation of the maximum satisfaction probability. Importantly, one can see that although 10 CDNFs in verification are ignored, one can still can obtain a very tight range of the satisfaction probability of φ₄ (10.0125, 0.01221). Therefore, ignoring large CDNFs with small probabilities is also one of the critical techniques to improve the scalability of described verification approach.

Reachable set traces visualization. One of the significant advantages of our verification approach is the ability to visualize satisfied traces, which helps users intuitively verify and interpret the verification results. FIG. 22B illustrates one satisfactory trace with probability (from steps 15 to 25) for

$${φ}_{4}^{′}$$

property with T=30 (note that there are multiple satisfactory traces for this property). For this visualization, one can clearly see that there is the case that when two cars go into an unsafe condition, i.e., Dᵣ≤D_{safe}, they keep staying in this condition for the next 5 steps. Note that all reachable set traces produced in the reachability analysis process can be visualized. It is interesting to explore in the future if one can use satisfactory traces to repair or retrain the neural network controller to increase its satisfactory probability for some specific properties.

The qualitative verification framework described herein allows for analyzing the temporal behaviors of learning-enabled systems (LES). The approach can be implemented in StarV and can successfully verify useful practical temporal properties of learning-enabled ACC systems. The timing performance, conservativeness, complexity, and scalability of the verification approach can be analyzed via experiment.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A qualitative and quantitative (Q²) method for verifying safety of movement of complex learning-enabled cyber-physical systems (Le-CPS) using a computer, the method comprising:
determining an initial set of states of the Le-CPS;
using the computer for determining a reachable set of the Le-CPS using a probstar reachability algorithm saved in memory of the computer;
using the computer including a Q² algorithm saved in the memory that is configured to simultaneously check (i) if the reachable set satisfies a predetermined safety constraint (qualitative verification) and (ii) determine a probability of satisfaction that the reachable set will satisfy the predetermined safety constraint (quantitative verification); and
planning movement of the Le-CPS based on the step of using the computer including the Q² algorithm.

2. The method of claim 1, wherein the Le-CPS comprises a vehicle comprising a neural network.

3. The method of claim 2 comprising controlling a speed of the vehicle based on the step of using the computer including the Q² algorithm.

4. The method of claim 3, wherein the vehicle comprises a perception component configured to automatically detect obstacles.

5. The method of claim 4 further comprising choosing a distance to for the Le-CPS to avoid detected obstacles.

6. The method of claim 2 comprising controlling an emergency braking system based on the step of using the computer including the Q² algorithm.

7. The method of claim 6, wherein the vehicle comprises a perception component configured to automatically detect obstacles.

8. The method of claim 1, wherein the probstar reachability algorithm using probstar algebra to compute the reachable set of the Le-CPS.

9. The method of claim 1, wherein the Q² algorithm comprises intersecting the reachable set with an unsafe constraint.

10. The method of claim 9, wherein the Q² algorithm comprises estimating a lower and upper bound of a violation probability.

11. A system configured to verify safety of movement of a complex learning-enabled cyber-physical system (Le-CPS) using a computer, the system comprising:
a computer comprising a memory comprising a probstar reachability algorithm and a Q² algorithm, the memory having instructions, which when executed by a processor, causes the computer to:
determine an initial set of states of the Le-CPS;
determine a reachable set of the Le-CPS using the probstar reachability algorithm;
use the Q² algorithm to (i) simultaneously check if the reachable set satisfies a predetermined safety constraint (qualitative verification) and (ii) determine a probability of satisfaction that the reachable set will satisfy the predetermined safety constraint (quantitative verification); and
plan movement of the Le-CPS based on use of the Q² algorithm by the computer.

12. The system of claim 11 further comprising a Le-CPS comprising a vehicle comprising a neural network configured to control operation of the vehicle.

13. The system of claim 12 comprising a controller configured to control a speed of the vehicle based on use of the Q² algorithm by the computer.

14. The system of claim 13, wherein the vehicle comprises a perception component configured to automatically detect obstacles.

15. The system of claim 14, wherein the computer determines the reachable set of the Le-CPS using a distance for the Le-CPS to avoid detected obstacles.

16. The system of claim 12 comprising a controller configured to control an emergency braking system based on use of the Q² algorithm by the computer.

17. The system of claim 16, wherein the vehicle comprises a perception component configured to automatically detect obstacles.

18. The system of claim 11, wherein the probstar reachability algorithm is configured to use probstar algebra to compute the reachable set of the Le-CPS.

19. The system of claim 11, wherein the Q² algorithm comprises intersecting the reachable set with an unsafe constraint.

20. The system of claim 19, wherein the Q² algorithm comprises estimating a lower and upper bound of a violation probability.
